(19) United States
(12) Patent Application Publication
(10) Pub. No.: US 2002/0123376 A1
(43) Pub. Date: Sep. 5, 2002

(54) System and method for providing reward points for casino play

(76) Inventors: Jay S. Walker, Ridgefield, CT (US); James A. Jorasch, Stamford, CT (US); Michael D. Downs, Stamford, CT (US); Geoffrey M. Gelman, Stamford, CT (US)

Correspondence Address: Michael D. Downs, Walker Digital, LLC, Five High Ridge Park, Stamford, CT, 06905, US

(21) Appl. No.: 10/136,050

(22) Filed: Apr. 30, 2002

Related U.S. Application Data
(63) Continuation-in-part of application No. 08/888,962, filed on Jul. 7, 1997, now Pat. No. 6,379,247.

(51) Int. Cl. G06F 19/00

(52) U.S. Cl. 463/11

(57) ABSTRACT

One embodiment of the present invention is directed to a method for awarding a number of reward points to a player of a table game, the method comprising the steps of: determining a wager amount corresponding to at least one play of at least one table game by a player; determining data associated with the at least one play, in which the data does not indicate the wager amount; determining whether the player is eligible for reward points based on the data; determining a number of reward points; and awarding the number of reward points to the player if the player is eligible for reward points.

This application is a continuation-in-part of U.S. Pat. application Ser. No. 08/888,962, filed on Jul. 7, 1997, incorporated herein by reference for all purposes.

### RELATED APPLICATIONS

This application is related to U.S. Pat. application Ser. No. 09/597,801, filed on Jun. 20, 2000, incorporated herein by reference for all purposes.

1. Field of the Invention

The present invention relates generally to gaming systems and, more particularly, to a system and method for providing table game players with reward points, such as frequent flyer miles.

2. Background of the Invention

In the competitive gaming industry, casinos seek new ways to attract and retain players of table games. One way casinos have attempted to attract and retain players is by awarding complimentary rewards known in the industry as “comps.” These comps, which are usually awarded based on the player's average wager and time played, typically include free drinks, meals, hotel accommodations, and the like.

While somewhat successful in retaining customers, casino comp systems have a significant cost associated with their use. In Atlantic City, for example, casinos awarded about $700 million in comps in 1995 alone.

In addition, comps such as room upgrades, free meals and drinks, typically must all be consumed within the particular casino that made the comp award. Away from the casino, the comps have no value. Expiration dates are also normally tied to these comps, with the value disappearing in as little as a day.

Another disadvantage of conventional casino comp systems is the lack of precision inherent in calculating the comp amount. To calculate a comp for a table game such as blackjack, an average bet is observed by supervisory casino personnel, and combined with an estimated hands per hour for the game. After receiving an indication from the player that the gaming session has ended, the casino calculates the time played and the resulting comp value. Player bets, however, may fluctuate dramatically throughout the gambling session. Unless directly observed by casino personnel and entered into the comp system as an adjustment, the variation is unaccounted for. The resulting comp may be inappropriately valued. Similarly, the rate of play may change dramatically depending on the number of players present at a particular gaming table. Once again, unless this figure is updated, comp values calculated will be incorrect, angering customers and resulting in comps having the opposite of the intended effect.

### BRIEF DESCRIPTION OF THE DRAWINGS

FIG. 1 is a block diagram illustrating an example system according to some embodiments of the present invention;

FIG. 2 is a block diagram illustrating an example of a gaming table as depicted in FIG. 1 according to some embodiments of the present invention;

FIG. 3 is a perspective view illustrating an example table processing unit and an example reward counter as depicted in FIG. 2;

FIG. 4 is a block diagram illustrating an example of a table processing unit as depicted in FIG. 2 according to some embodiments of the present invention;

FIG. 5 is a block diagram illustrating an example of a cashier terminal as depicted in FIG. 1 according to some embodiments of the present invention;

FIG. 6 is a block diagram illustrating an example of a reward counter as depicted in FIG. 2 according to some embodiments of the present invention;

FIG. 7 is a block diagram illustrating an example of a central controller as depicted in FIG. 1 according to some embodiments of the present invention;

FIG. 8 is a table illustrating an example data structure of an example rewarded miles database as depicted in FIG. 7 for use in some embodiments of the present invention;

FIG. 9 is a table illustrating an example data structure of an example player database as depicted in FIG. 7 for use in some embodiments of the present invention;

FIG. 10 is a table illustrating an example data structure of an example session database as depicted in FIG. 7 for use in some embodiments of the present invention;

FIG. 11 is a table illustrating an example data structure of an example play database as depicted in FIG. 7 for use in some embodiments of the present invention;

FIG. 12 is a table illustrating an example data structure of an example award criteria database as depicted in FIG. 7 for use in some embodiments of the present invention; and

FIGS. 13A and 13B illustrate in a flow diagram an exemplary process for awarding frequent flyer miles to a player of a table game according to and for use in some embodiments of the present invention;

FIG. 14 is a flow diagram illustrating an exemplary process for assigning awarded frequent flyer miles to a player's account according to and for use in some embodiments of the present invention;

FIG. 15 is a flow diagram illustrating an exemplary process for updating an airline mileage tracking system according to and for use in some embodiments of the present invention;

FIG. 16 is a block diagram illustrating an example system according to some alternative embodiments of the present invention;

FIG. 17 is a flow diagram illustrating an alternative exemplary process for awarding reward points to a player of a table game according to and for use in some embodiments of the present invention;

FIG. 18 is a flow diagram illustrating an alternative exemplary process for awarding reward points to a player of a table game according to and for use in some embodiments of the present invention; and

FIG. 19 is a flow diagram illustrating an alternative exemplary process for awarding reward points to a player of a table game according to and for use in some embodiments of the present invention.

### DETAILED DESCRIPTION OF EMBODIMENTS

Various embodiments of the present invention provide a player with rewards, particularly those having a high perceived value to the player. In accordance with some embodiments of the present invention, a system rewards play of a casino table game with reward points, such as frequent flyer miles, in addition to any payout based on such play. According to some embodiments, such rewards are capable of being awarded on a per-play basis.

When a player stops playing, the casino or the gaming site might earn no additional revenue from the player. Various embodiments of the present invention provide the benefit that a casino or other gaming operator may create a more enjoyable and entertaining experience for players of table games. An award can benefit casinos or other gaming operators by helping to attract players, and/or by helping to retain players who are already playing. By increasing the number of players, casinos and other gaming operators can generate additional revenues and profits.

Exemplary reward points include, but are not limited to: frequent flyer miles, frequent shopper points, points to be used for game entries on Internet game site, points for use in obtaining discounts on purchases, points for use in making phone calls (e.g., phone minutes), and points for use in obtaining gasoline. Such reward points provide the benefit of enabling a casino to reward players with a low-cost award that is more flexible than typical comps, and therefore may have a higher perceived value to the players.

Also, various embodiments of the present invention provide the benefit of making it more likely to attract and/or retain players who may get frustrated, disappointed, or discouraged during play of a table game. If, for example, a player has already lost a number of hands and believes that he is on an “unlucky” streak, he may become frustrated or discouraged, and may stop playing and/or leave the gaming venue (e.g., by leaving the casino, or logging off an online gaming site). By providing an award in accordance with some embodiments of the present invention, such players may be more likely to continue playing the table game.

In various embodiments of the present invention, a method for rewarding complimentary frequent flyer miles includes establishing a casino table game, tracking player wagering on the game, and awarding a payout based on the outcome of the game. In addition to awarding the payout, if any, the method includes storing electronic data representing a number of complimentary frequent flyer miles awarded to a player, and linking the electronic data with the stored player identifying information. An apparatus for tracking such complimentary rewards is also disclosed.

In various embodiments of the present invention, a method for receiving complimentary frequent flyer miles includes the steps of making a wager on a game, playing the game to a resultant outcome, and receiving a payout based on the outcome. In addition to receiving the payout, which may be zero, the method includes the steps of indicating the end of play of the game and causing data representing a number of complimentary frequent flyer miles to be stored in a database. In alternate embodiments, the number of miles is based on the occurrence of the wager or the amount of the wager.

According to various embodiments of the present invention, information about the player and/or information about play of a table game may be used in determining whether to provide a number of reward points to a player. In various supplemental or additional embodiments, such information may also be used in determining the number of reward points to give to a player.

According to some embodiments, the awards can be provided by a dealer, casino or other gaming operator to particular players, in order to entice such players to play at the casino, to retain such players, and/or to encourage such players to return. Such players may include, for example: first-time players; “high-rollers” (e.g., players who tend to bet relatively large sums of money either at once or over time); players likely to be frustrated or discouraged (e.g., a player who feels he is “unlucky”), players who tend to play games which provide the house with a relatively large edge, or players who tend to make decisions during play that provide the house with a larger edge relative to other decisions the player might have made (e.g., players, such as unskilled or inexperienced players, who make decisions contrary to an appropriate strategy for play).

In some embodiments of the present embodiment, miles are preferably awarded only for a losing wager. By awarding only for losing wagers, a casino may attract and retain players and, at the same time, reduce the typically high costs of comp systems. Specifically, players will remain playing because even if they lose money, they win miles. Of course, it is within the scope of this invention to award miles to all players, including winners, losers, players who tie (e.g., “push”, “draw”), or any combination of such players.

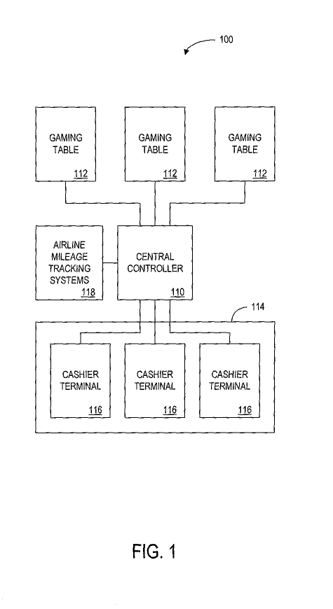

Certain preferred embodiments of the present invention will now be described with reference to the drawings. Turning first to FIG. 1, there is shown a system 100 in accordance with various embodiments of the present invention. In general, the system 100 includes a central controller 110, such as a casino network server, having a plurality of gaming tables 112 in communication therewith. It is to be understood that the gaming tables 112 may be used for any type of table game, such as blackjack, craps, roulette, Pai Gow, Pai Gow poker, baccarat, craps, casino war, Caribbean stud poker, Sic Bo, roulette, 21, Big Six, Texas hold'em poker, seven card stud poker, Omaha poker and the like, or any combination thereof.

It is also to be understood that the gaming tables 112 are preferably in communication with the central controller 110 via a hardwired and/or wireless communication network, such as a local area network, a wide area network, or the Internet.

Also in communication with the central controller 110 is one or more casino cages 114. As described in greater detail below, the casino cage 114 is a location, preferably in the casino, where players may redeem frequent flyer mileage receipts. To this end, the casino cage 114 includes a plurality of cashier terminals 116. Like each of the gaming tables 112, each cashier terminal 116 is in communication with the central controller 110.

As described in detail below, according to some embodiments of the present invention, the central controller 110 stores records of the number of frequent flyer miles or other reward points awarded to a given player and assigned to a given account, such as a frequent flyer account. The central controller 110 is also in communication with at least one participating airline's mileage tracking system 118 so that this stored information may be transferred to the appropriate airline. Airline mileage tracking system 118 represents a conventional system as operated by a commercial airline to maintain frequent flyer records. Such programs and systems are well known to those of ordinary skill in the art of airline travel.

Any of the controller 110, the gaming tables 112, the casino cage 114, and the airline tracking system 118 may be physically proximate to any other device depicted in FIG. 1 or may be geographically remote from any other such device.

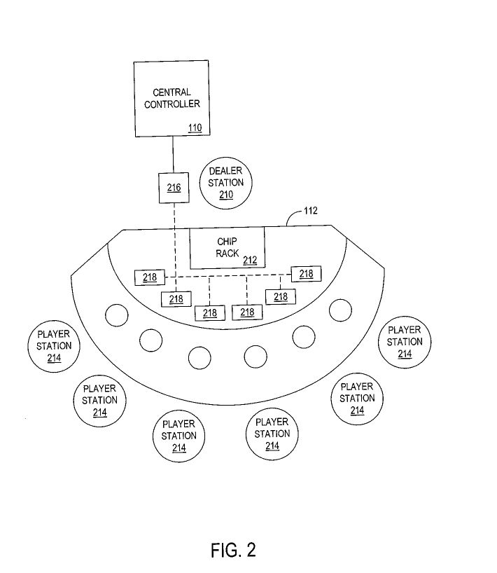

A gaming table 112 and its associated components will now be described in greater detail with reference to FIG. 2, and continuing reference to FIG. 1. As with existing gaming tables, the gaming table 112 includes a dealer station 210, a dealer chip rack 212, and multiple player stations 214. The gaming table 112 preferably includes a table processing unit 216, which is located adjacent to the dealer station 210, and reward point or mileage counters 218, each of which is located adjacent to a player station 214. All of the mileage counters 218 are in communication with the table processing unit 216, which, in turn, is in communication with the central controller 110.

As described in detail below with respect to some embodiments, the dealer enters an input into a mileage counter 218 to register a reward of frequent flyer miles for a particular player. In various embodiments, the dealer input includes the amount wagered by the player. Also described below, the table processing unit 216 communicates reward information to the central controller 110. Such reward information includes any information used to identify or authenticate a reward.

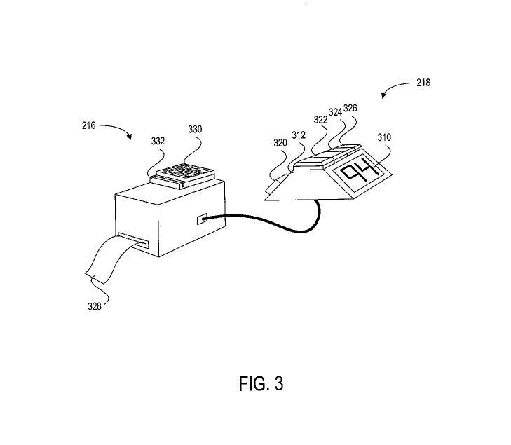

The table processing unit 216 and the mileage counter 218 will now be described in greater detail with reference to FIG. 3. The mileage counter 218 includes a player mile count display 310 for displaying the number of award miles accumulated by each player at the gaming table 112, a dealer mile count display 312 (not visible), for displaying the same information to the dealer, and a series of buttons for use by the dealer.

More particularly, the buttons of the mileage counter 218 include a reset button 320 for resetting the mileage counter 218 and, in various embodiments, a series of three mile counter buttons 322, 324, 326. Of course, any number of mile counter buttons may be used. Each of the three mile counter buttons 322, 324, 326 correspond to a discrete range of a player's potential wager and, therefore, to a discrete number of miles potentially awarded. For example, the first mile counter button 322 corresponds to a wager below fifty dollars and ten frequent flyer miles; the second mile counter button 324 corresponds to a wager of fifty to one hundred dollars and twenty-five frequent flyer miles; and third mile counter button 326 corresponds to wagers over one-hundred dollars and fifty frequent flyer miles.

As will be appreciated by those skilled in the art, mile counter buttons 322, 324, 326 that correspond to predetermined ranges of wagers and numbers of miles provide several benefits to the casino. Because each mile counter button corresponds to a predetermined range of wagers, during operation the dealer need only press one of the relatively few buttons, rather than enter each player's specific wager on a ten-digit keypad. Thus, as described in greater detail below, operation of the system 100 proceeds quickly and is seamlessly incorporated into normal casino play at the gaming table 112. Additionally, casinos can easily correlate a disproportionately high number of miles to the highest range of wagers, thereby encouraging players to wager greater amounts of money.

in an alternate embodiment, however, the mileage counter 218 includes a keypad for entering the exact amount wagered by the player. The mileage counter 218 then multiplies the amount wagered by a mileage factor, such as one-half mile per dollar wagered, to determine the miles awarded. In another alternate embodiment, the mileage counter 218 includes a graduated mileage factor which allows for relatively higher wagers to receive relatively greater miles per dollar. Again, such an embodiment encourages players to wager greater amounts of money, thereby contributing to a casino's earnings.

In yet another alternate embodiment, the dealer inputs the actual reward, or the number of frequent flyer miles awarded. It is to be understood that the dealer input may include, in alternate embodiments, either the amount wagered or the number of miles awarded because the amount wagered and the number of miles are essentially alternate representations of the same information. Therefore, it is also to be understood that the mileage counters 218 are, in alternate embodiments, used to track and accumulate either the amounts wagered or the actual rewards.

Also shown in FIG. 3 is the table processing unit 216. The table processing unit 216, which communicates with the mileage counters 218, includes a mileage receipt printer (not shown). in various embodiments, the mileage receipt printer is internal to the table processing unit 216. As discussed in greater detail below, the mileage receipt printer prints a mileage receipt 328 that is provided to a player and indicates the number of miles awarded at the gaming table 112. Although the mileage receipt 328 is described as a printed receipt, it is within the scope of the present invention to have mileage receipts that are special chips.

The table processing unit 216 also includes a keypad 330 and a card reader 332. In an alternate embodiment, the card reader is used to read a dealer's unique dealer identification (ID) number from a dealer's identification (ID) card. In one embodiment, the dealer ID card has a magnetic strip which stores the dealer ID number. In another alternate embodiment, the dealer merely enters the dealer ID number via the keypad 330. As discussed below, the dealer ID number, which is communicated to the central controller as reward information, may be used for casino audits or as authenticating information.

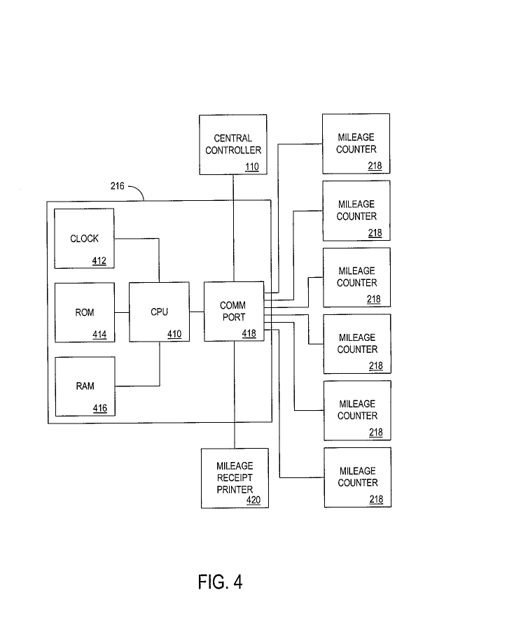

The table processing unit 216 will now be described in greater detail with reference to FIG. 4. The table processing unit 216 includes a central processing unit (“CPU”) 410 and an associated system clock 412. The CPU 410 executes instructions according to a program stored in a read only memory (“ROM”) 414. In accordance with its operation, as discussed below, the CPU 410 periodically stores and reads data in a random access memory (“RAM”) 416 to which it is coupled.

Also coupled to the CPU 410 is a communications port 418. The communications port 418, in turn, is coupled to the mileage counters 218. Therefore, the table processing unit 216 is able to pass data and signals between each mileage counter 218. Because the communications port 418 is also coupled to the mileage receipt printer 420, the CPU 410 is also able to send data and signals, and thereby control, the mileage receipt printer 420. Lastly, the communications port 418 is coupled to the central controller 110 to allow communication between the table processing unit 216 and the central controller 110.

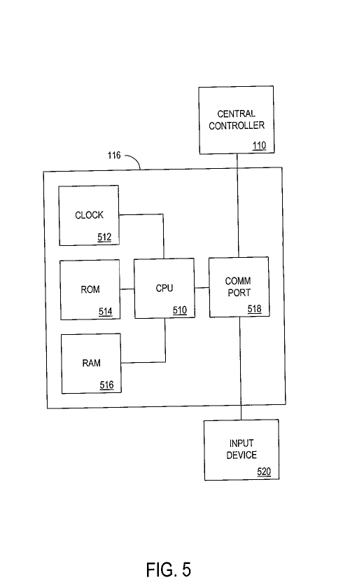

The cashier terminal 116 will now be described with reference to FIG. 5. Like the table processing unit 216, the cashier terminal 116 includes a CPU 510 and an associated system clock 512. The CPU 510 executes instructions according to a program stored in ROM 514. During its operation, the CPU 510 periodically stores data in and reads data from RAM 516, to which it is coupled.

Also like the table processor 216, the cashier terminal 116 includes a communications port 518. The communications port 518 provides a communication path between the CPU 510 and the central controller 110, thereby allowing an exchange of data therebetween. An input device 520 is also coupled to the communications port 518 and, therefore, in communication with the CPU 510. It is to be understood that the input device 520 is in alternate embodiments, a keypad, touchscreen, a voice recognition interface, and the like. As described in detail below, the cashier terminal 116 is used by casino personnel to assign awarded miles to a player's frequent flyer account and to transfer the assigned miles to the appropriate airline mileage tracking system 118.

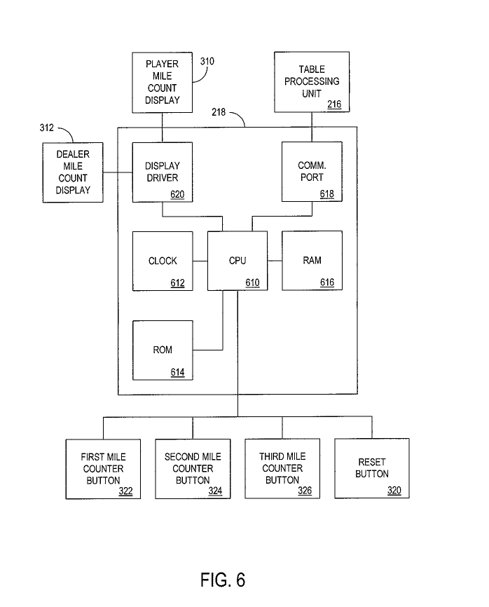

The mileage counter 218 will now be described in greater detail with reference to FIG. 6 and continuing reference to FIG. 3. The mileage counter 218 includes a CPU 610 and an associated system clock 612. The CPU 610 performs instructions according to a program stored in ROM 614. During execution of the program, the CPU periodically stores data in and retrieves data from a RAM 616 coupled thereto.

As noted above, the mileage counter 218 also includes a player mile count display 310 and a dealer mile count display 312. In order to control the output of these displays 310, 312, a display driver 620 is interposed between the CPU 610 and the displays 310, 312.

Also noted above, the mileage counter 218 includes the reset button 320 and the first through third mile counter buttons 322, 324, 326. Each of these buttons are also coupled to the CPU 610. It is to be understood that these buttons and the corresponding signals may be implemented in any number of ways, including in hardware, as a toggle switch, touchscreen, or the like, and/or in software, as a software flag, for example.

Lastly, the mileage counter 218 includes a communications port 618 to which both the CPU 610 and the table processing unit 216 are coupled. Thus, the mileage counter 218 and the table processor 216 may freely exchange information as necessary. Furthermore, because the table processing unit 216 is coupled to the central controller 110, the mileage counter 218 may exchange information with the central controller 110.

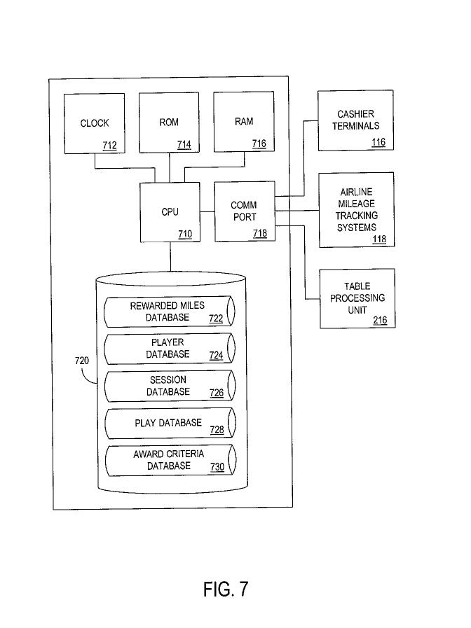

The central controller 110 will now be described with reference to FIG. 7. As with the previously described components of the system 100, the central controller 110 includes a CPU 710 and an associated system clock 712. The CPU 710 executes instructions according to a program stored in a ROM 714. During the execution of instructions, the CPU 710 stores data in and retrieves data from a RAM 716 coupled thereto.

The central controller 110 also includes a communications port 718 coupled to the CPU 710. The communications port 718 allows the central controller 10, via its CPU 710, to communicate with the other components of the system 100. Specifically, the communication port 718 is coupled to the table processing units 216, cashier terminals 116, and airline mileage tracking system 118.

In order to manage the information generated by the system 100, the central controller 110 includes a data storage device 720, such as one or more magnetic, optical, or suitably equivalent diskette drives. The data storage device 720 is operative to store (i) a rewarded miles database 722, (ii) a player database 724, (iii) a session database 726, (iv) a play database 728, and (iv) an award criteria database 730. The databases 722, 724, 726, 728, 730 are described in detail below and example structures are depicted with sample entries in the accompanying figures.

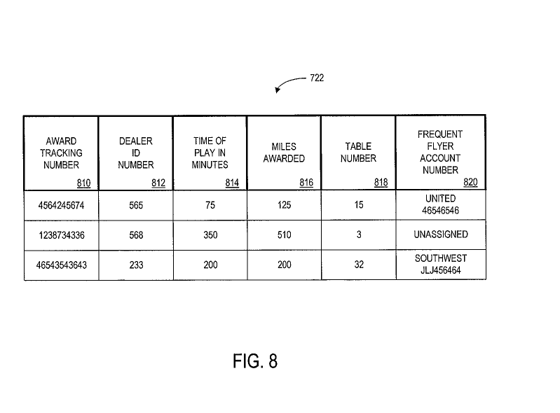

The rewarded miles database 722 will now be described with reference to FIG. 8. The rewarded miles database 722 includes a record concerning each award of mileage, as identified by an award tracking number. Specifically, each record includes an award tracking number field 810, a dealer identification (ID) number field 812, a time of play in minutes field 814, a miles awarded field 816, a table number field 818, and a frequent flyer account number field 820.

As discussed in greater detail below, the system assigns an award tracking number to each individual award of frequent flyer miles. This number is stored in the award tracking number field 810. According to various embodiments, each dealer in the casino has an individual and unique identification number (“ID”). in some alternative embodiments, each dealer need not have a unique ID number. The ID number of the dealer that awarded the miles identified by the award tracking number 810 is stored in field 812. The duration of play required to achieve the awarded miles 816 is stored in the time of play field 814. Field 816 stores the number of miles awarded corresponding to the awarded tracking number 810. According to various embodiments, each gaming table 112 has a unique number. In some alternative embodiments, each gaming table 112 need not have a unique number. The number of the table at which the mileage award corresponding to the award tracking number 810 was made is stored in field 818. Lastly, the frequent flyer account number field 820 stores the account number to which the miles awarded 816 have been assigned. If the miles have yet to be assigned, then an indication that such miles are unassigned is stored in the frequent flyer account number field 820.

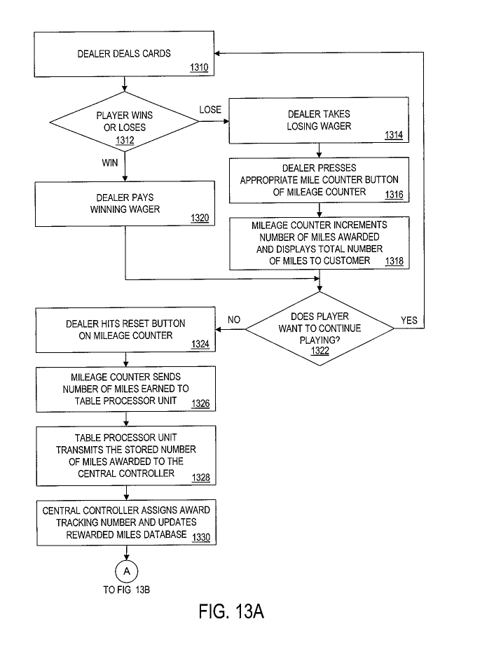

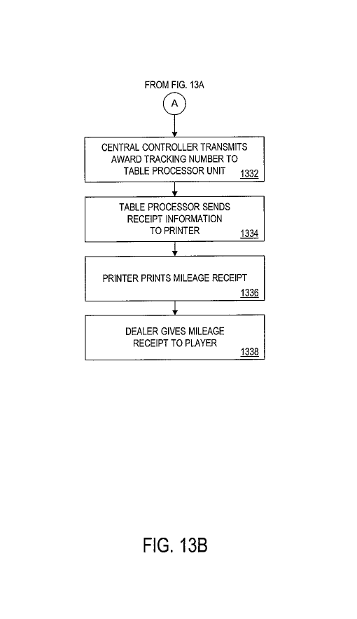

It is to be understood that the different fields in the rewarded miles database 722 serve different functions. For example, the dealer ID number field 812 and the table number field 818 may be used to identify abnormally high awards of miles by any particular dealer. As described below, such information may also be used to authenticate awards of miles by encoding such information into the award tracking number 810. Similarly, the time of play in minutes field 814 may be used to check whether the relationship between the amount wagered and the number of miles awarded is acceptable to the casino. Use of the remaining fields in the rewarded miles database 722 will be described below, in connection with the flow diagrams of FIGS. 13-15.

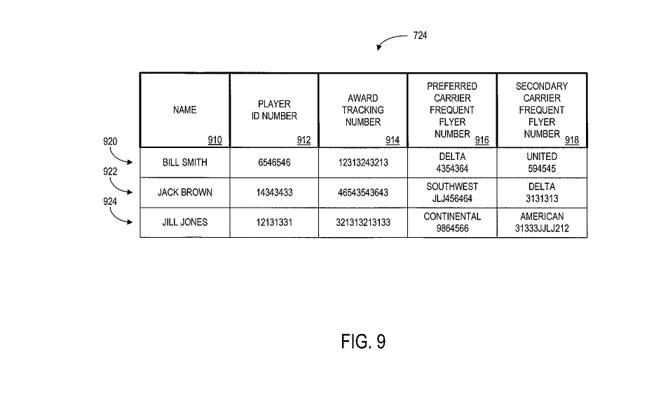

The player database 724 will now be described in greater detail with reference to FIG. 9. In general, the player database 724 includes multiple records 920, 922, 924, each of which correlates player identifying information with a particular award of mileage. Such player identifying information includes the player's name, as stored in the name field 910, the player's identification (ID) number, as stored in the player ID number field 912, and the player's frequent flyer accounts. The player's frequent flyer accounts are stored in the preferred carrier frequent flyer account field 916 and the secondary carrier frequent flyer account field 918. The player database 724 also includes an award tracking number field 914.

It is understood that inclusion of the award tracking number field 914 allows information in the player database 724 to be correlated with information in the rewarded miles database 722 for the same award tracking number. Thus, for example, based on the information in the player database 724, record 922, “JACK BROWN” received an award of miles having an associated award tracking number 914 of “46543543643.” Locating this award tracking number 810 in the rewarded miles database 722 indicates that, for this particular award of miles, Mr. Brown received 200 miles, as indicated in the miles awarded field 816. Mr. Brown assigned these miles to his frequent flyer account number “SouthWest JLJ456464.” Furthermore, Mr. Brown won these miles by playing at table number 32, as indicated in the table number field 818, played for 200 minutes, as indicated in the time of play in minutes field 814, and was awarded the miles by the dealer having the ID number 233, as identified in field 812. It should be noted that correlation of the data between the player database 724 and the rewarded miles database 722 could also be made based upon the frequent flyer account information in field 820 of the rewarded miles database 722 and fields 916 and 918 of the player database 724.

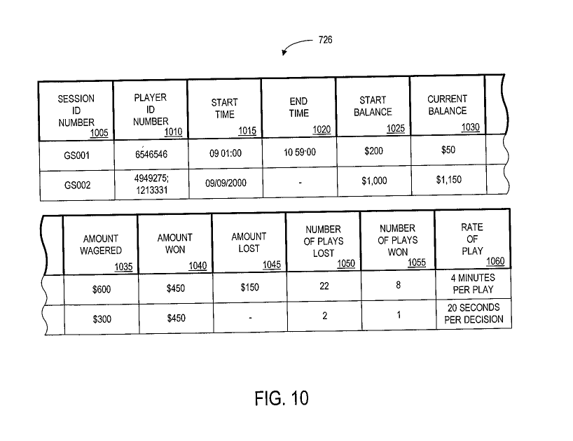

Turning to FIG. 10, a tabular representation of an embodiment of session database 726 according to some embodiments of the present invention is illustrated. This particular tabular representation of a session database 726 includes two sample records or entries which each include information regarding a particular gaming session. A gaming session corresponds to one or more plays (e.g., hands, deals) of one or more table games. A gaming session may correspond, for example, to gaming activity since commencing play at a gaming table or at a casino, and/or to gaming activity during a particular period of time (e.g., a day, a two-hour period, a month, a stay at a casino or hotel). It will be understood that the plays corresponding to a particular gaming session need not have taken place one after another (e.g., need not be consecutive).

In some embodiments, more than one player may be associated with a gaming session. For example, two or more players may be associated with one another (e.g., as members of a team, as spouses). Thus, a gaming session may include at least one play by each of the related players. Alternatively, the gaming session may be associated with plays by only a subset of the related players.

In some embodiments of the invention, the session database 726 is used to track gaming session information such as a session identifier, player identifiers, award tracking numbers, table identifiers, a start time, an end time, a start balance, a current balance, a total amount wagered, a total amount won, a total amount lost, a number of plays lost, a number of plays won, a number of plays tied, and a rate of play. Those skilled in the art will understand that a session database 726 may include any number of records or entries.

The particular tabular representation of a session database 726 depicted in FIG. 10 defines a number of fields for each of the entries or records. The fields may include: (i) a session ID number field 1005 that stores a representation uniquely identifying a gaming session; (ii) a start time field 1010 that stores a representation of a time the gaming session started; (iii) an end time field 1015 that stores a representation of a time the gaming session ended; (iv) a start balance field 1020 that stores a representation of a balance available for gaming at the start of the gaming session; (v) a current balance field 1025 that stores a representation of a balance currently available for gaming; (vi) a total amount wagered field 1030 that stores a representation of an amount wagered during the gaming session; (vii) a total amount won field 1035 that stores a representation of an amount won during the gaming session; (viii) a total amount lost field 1040 that stores a representation of an amount lost during the gaming session; (ix) a number of plays lost field 1045 that stores a representation of the number of plays lost during the gaming session; (x) a number of plays won field 1050 that stores a representation of the number of plays won during the gaming session; and (xi) a rate of play field 1055 that stores a representation of the rate at which plays were completed and/or decisions were made during the gaming session.

The example session database 726 of FIG. 10 provides example data to illustrate the meaning of the information stored in this database embodiment. The first sample entry is directed to a gaming session “GS001” associated with player “6546546” that started at “09:01:00” and ended at “10:59:00”. The session started with an available balance of “$200” and the current balance (the ending balance in this example) is “$50”. During the course of the session, “$600” was wagered and “$450” was won. Accordingly, “$150” was lost. Player “6546546” won “8” table game plays and lost “22” plays, and played at a rate of “4 MINUTES PER PLAY”.

The second sample entry is directed to a gaming session “GS002” associated with players “4949275” and “12131331” that started on “Sep. 9, 2001” and has not yet ended. The session started with an available balance of “$1000” and the current balance is “$1150”. During the course of the session, “$300” has been wagered and “$450” has been won. Accordingly, no amount lost is provided. During the session “1” table game play was won and “2” table game plays were lost. The rate of play indicates “20 SECONDS PER DECISION”.

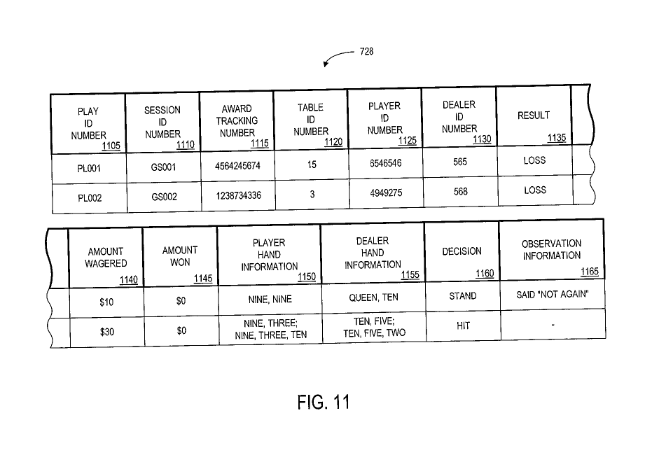

Turning to FIG. 11, a tabular representation of an embodiment of play database 728 according to some embodiments of the present invention is illustrated. This particular tabular representation of a play database 728 includes two sample records or entries which each include information regarding a particular play of a table game.

The particular tabular representation of a play database 728 depicted in FIG. 11 defines a number of fields for each of the entries or records. The fields may include: (i) a play ID number field 1105 that stores a representation uniquely identifying a play of a table game; (ii) a session ID number field 1110 that stores a representation of one or more session ID numbers associated with the play; (iii) an award tracking number field 1115 that stores a representation of an award tracking number associated with the play; (iv) a table ID number field 1120 that stores a representation uniquely identifying a gaming table associated with the play; (v) a player ID number field 1125 that stores a representation identifying a player associated with the play; (vi) a dealer ID number field 1130 that stores a representation identifying a dealer associated with the play; (vii) a result field 1135 that stores a representation of a result or outcome of the play; (viii) an amount wagered field 1140 that stores a representation of an amount wagered during the play; (ix) an amount won field 1145 that stores a representation of an amount won during the play; (x) a player hand field 1150 that stores a representation or description of information about one or more hands held by the player during the play; (xi) a dealer hand field 1155 that stores a representation or description of information about one or more hands held by the dealer during the play; (xii) a decision field 1160 that stores a representation of one or more decisions made by the player during the play; and (xiii) an observation information field 1165 that stores a representation or description of information about actions, utterances, or other behavior by the player during the play.

The example play database 728 of FIG. 11 provides example data to illustrate the meaning of the information stored in this database embodiment. The first sample entry is directed to a play “PL001” associated with player “6546546” and session “GS001”. The play has an associated award tracking number “4564245674” and took place at table number “15” with dealer “565”. During the play the player held “NINE, [and] NINE”, and the dealer held “QUEEN, [and] TEN”. The player made a decision to “STAND”. The player wagered “$10” and won “$0” and the result was a “LOSS”. Sometime during the play, the player was observed saying “NOT AGAIN!”

The second sample entry is directed to a play “PL002” associated with player “4949275” and session “GS002”. The play has an associated award tracking number “1238734336” and took place at table number “3” with dealer “568”. During the play the player held “NINE, [and] THREE” against a dealer's hand of “TEN, [and] FIVE” and decided to “HIT”. The player received a “TEN” and the dealer received a “TWO”. The player wagered “$30” and won “$0”, and the indicated result was a “LOSS”.

In some alternative embodiments, more than one gaming session may be associated with the same play. For example, one gaming session might refer to a particular two-hour period during which a player played one or more table games at a casino, and a different gaming session might be associated with all plays by the player during the player's entire stay at the casino, which would include the first gaming session.

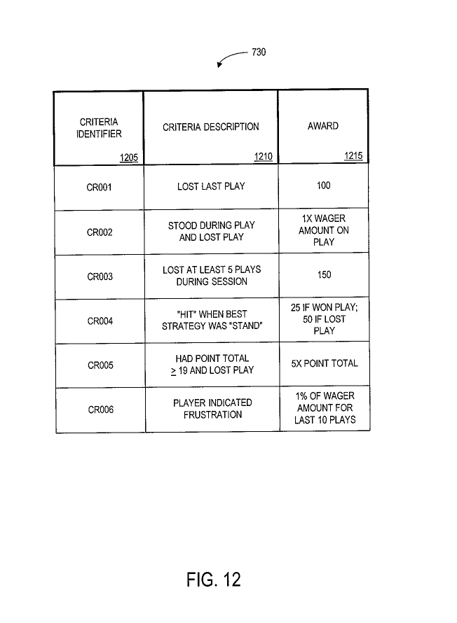

Turning to FIG. 12, a tabular representation of an embodiment of award criteria database 730 according to some embodiments of the present invention is illustrated. This particular tabular representation of a award criteria database 730 includes several sample records or entries which each include information regarding particular criteria for providing an award to a player.

The particular tabular representation of award criteria database 730 depicted in FIG. 12 defines a number of fields for each of the entries or records. The fields may include: (i) a criteria ID number field 1205 that stores a representation uniquely identifying one or more criteria for providing an award to a player of a table game; (ii) a criteria description field 1210 that stores a representation or description of the one or more criteria for providing the award; and (iii) an award field 1215 that stores a representation or description of one or more awards associated with the criteria.

The example award criteria database 730 of FIG. 12 provides example data to illustrate the meaning of the information stored in this database embodiment. The first sample entry is directed to criteria identified as “CR001”. The condition for providing an award is described as whether the player “LOST [the] LAST PLAY”, and there is a corresponding award of “100” reward points.

The fifth sample entry is directed to criteria identified as “CR005”. The condition for providing an award is described as whether the player “HAD [a] POINT TOTAL≧19 AND LOST PLAY”. In this example, the corresponding award of “5× POINT TOTAL” indicates that the player may receive an award or reward points equal to five times the player's point total in the play. The second, third, fourth and sixth sample entry provide other examples of criteria and associated awards. As described below, however, an award need not be pre-associated with certain criteria, but may be determined by various other means.

It is to be understood that alternate arrangements of stored data are also within the scope of the present invention. For example, the databases 722, 724, 726, 728, 730 may be combined into a single database, or the stored data may be arranged within more than five databases. Additionally, not all of the fields are necessary for implementation of the present invention. For example, the name field 910 may be omitted, thereby allowing for an anonymous award of miles. Additional fields may also be included in any of the databases described herein.

Having thus described the components of the system 100, operation of the system 100 will now be described with reference to FIGS. 13A and 13B and continuing with reference to FIGS. 4, 6 and 7. It is to be understood that the operation of the system, as described below, may be controlled primarily by programs stored within the respective components 216, 116 and 110 and executed respectively in the ROMs 414, 614, 714 of the system components.

Initially, in step 1310, the dealer deals the playing cards. Once the hand is played, the dealer determines whether the player wins or loses in step 1312. If the dealer determines that the player has lost, then, in step 1314, the dealer takes the losing wager. As the dealer takes the losing wager, he proceeds to press the appropriate mile counter button 322, 324, 326 of the mileage counter 218. Pressing the appropriate mile counter button 322, 324, 326, shown in step 1316, requires virtually no additional time as the dealer is able to press the button in the same motion as taking the wager.

Pressing a mile counter button 322, 324, 326 causes the mileage counter 218 to increment the number of miles awarded to this particular mileage counter 218 in step 1318. The total number of miles awarded to each mileage counter 218 is stored in the RAM 616 of that mileage counter 218. The mileage counter 218 also displays the total number of miles awarded to the player associated with the particular mileage counter 218.

If, in step 1312, the dealer had determined that the player had won, then the dealer would have paid the winning wager. The step of paying the winning wager is shown in 1320. According to some alternative embodiments, the dealer may determine that the player tied the dealer (e.g., “push”, “draw”). in such a case, the dealer would preferably return the player's wager.

After the dealer has either paid the winning wager in step 1320 or caused the mileage counter 218 to increment the number of miles awarded in step 1318, the dealer determines in step 1322 whether the player wants to continue playing. If the player desires to continue, then the operation of the system 100 continues with step 1310. On the other hand, if the player desires to stop playing, then operation continues with step 1324. For example, a player's departure from the gaming table 112 may be automatically detected.

in step 1324, the dealer hits the reset button 320 on the mileage counter 218. Pressing the reset button 320 causes the mileage counter 218 to transmit the number of miles awarded to the table processing unit 216. Communicating the number of miles awarded to the table processing unit 216 occurs in step 1326.

Once the table processing unit 216 receives the number of miles awarded, it proceeds to transmit the number of miles awarded to the central controller in step 1328. Also in step 1328, the table processing unit 216 transmits the table number, dealer ID number, and time of play to the central controller 110. The table number is preprogrammed into the table processing unit 216 and the dealer ID number is entered by the dealer via either the keypad 330 or by swiping an identification card into the card reader 332.

After receiving the information in step 1328, the central controller 110 assigns an award tracking number to the information and enters the information in the appropriate fields in a record in the rewarded miles database 722. Entering the information in the rewarded miles database is shown in step 1330. Once the central controller 110 assigns the award tracking number and updates the rewarded miles database 722, the central controller 110 proceeds to transmit the award tracking number to the table processing unit 216 in step 1332.

Once the table processing unit 216 receives the reward tracking number 810, it proceeds to send receipt information to the mileage receipt printer 420. In the present embodiment, the receipt information includes the award tracking number and the miles awarded. In an alternate embodiment, the receipt information also includes the player ID number so that only a particular player may redeem the extended miles. Communication of the receipt information from the table processing unit 216 to the mileage receipt printer 420 is shown as step 1334.

Upon receiving the receipt information, the printer 420 prints the mileage receipt 328 in step 1336. The dealer retrieves the mileage receipt 328 and, in step 1338, gives the mileage receipt 328 to the player.

It is to be understood that speed of play is important to a casino because the speed of play is directly proportional to the amount wagered by players and won by the casino. Based on the foregoing description, it will be apparent to those skilled in the art that operation of the present embodiment preferably proceeds without disrupting or slowing normal play. Dealer intervention is minimal, involving pressing a mile counter button 322, 324, 326 when retrieving a player's wager and hitting the reset button 320 when a player leaves the gaming table 112. Therefore, fluidity of play remains and the speed of play is unaffected.

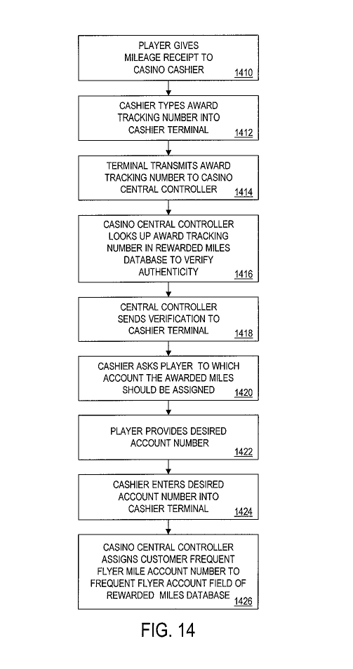

The process of assigning awarded miles to a frequent flyer account will now be described with reference to FIG. 14. Initially, in step 1410, the player goes to the casino cage 114 and gives the mileage receipt 328 to the casino cashier. Then, in step 1412, the cashier types the award tracking number, which is printed on the mileage receipt 328, into the cashier terminal 160. Once the cashier enters the award tracking number, the cashier terminal 116 transmits the number to the casino central controller 110. Transmitting the award tracking number to the casino central controller 110 is shown as step 1414.

Having received the award tracking number, the central controller 110 accesses the rewarded miles database 722 and searches for the received award tracking number. This searching, shown as step 1416, allows the system 100 to verify the authenticity of the mileage receipt 328. Specifically, if the received award tracking number is found in the rewarded miles database 722 and has not been assigned to a frequent flyer account already, then the mileage receipt 328 is deemed authentic. On the other hand, if the award tracking number is not found in the rewarded miles database 722 or if the awarded miles have already been assigned to a frequent flyer account, then the mileage receipt 328 is deemed to be fraudulent. Assuming that the award tracking number is located in the rewarded miles database 722, the central controller 110 proceeds, in step 1418, to send a verification signal back to the cashier terminal 116.

Once the cashier terminal 116 receives the verification, it prompts the cashier to ask the player to which account number the awarded miles should be assigned. Requesting the account number is shown as step 1420.

In response, as shown in step 1422, the player gives the casino cashier the desired account number. The casino cashier, in turn, enters the desired account number into the cashier terminal 116 in step 1424. More specifically, in the present invention, the player simply states that the preferred carrier frequent flyer account 916 should be used.

Finally, having received the account number to which the awarded miles are to be assigned, the central controller 110 assigns the player's frequent flyer mile account number to the awarded miles. Specifically, in step 1426, the central controller 110 accesses the rewarded miles database 722, locates the record having the received award tracking number in field 810, and enters the desired frequent flyer account number in the frequent flyer account number field 820. Thus, the player's awarded miles have been assigned to the specific frequent flyer account.

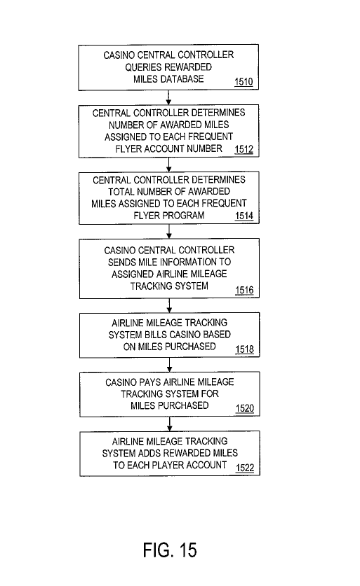

The process of transferring awarded miles to the assigned airline mileage tracking systems will now be described with reference to FIG. 15. It is anticipated that the process of transferring the awarded miles will take place periodically and will be initiated by casino personnel by selecting a program option at the cashier terminal 116.

As an initial step in the transfer process, the casino central controller 110 queries the rewarded miles database 722 in step 1510. Having queried the database 722, the central controller 110 determines the number of awarded miles assigned to each unique frequent flyer account number. Specifically, in step 1512, the CPU 710 queries the frequent flyer account number field 820 in the rewarded miles database 722 and, for each unique account number, tabulates the total number of miles assigned. This information is stored in RAM 716 or, alternatively, in the data storage device 720. Next, in step 1514, the central controller 110 determines the total number of awarded miles assigned to each frequent flyer program for each airline. Again, this is achieved by the CPU 710 searching the frequent flyer account number field 820 and tabulating in memory the total number of awarded miles for each such program.

Having determined the total number of awarded miles assigned to each frequent flyer account number, as well as the total number of awarded miles assigned to each airline frequent flyer program, the central controller 110 sends this mileage information to the appropriate airline mileage tracking system 118. Sending this information to the airline mileage tracking system 118 is shown as step 1516. It is to be understood that the communication between the central controller 110 and the airline mileage tracking system 118 may occur via a hard-wired connection, as in the present invention, or may be some other type of communication. Such hard-wired connections include wide area networks, connections over a public switch network, and the like. In an alternate embodiment, communication between the central controller 110 and the airline mileage tracking systems 118 occurs via wireless communication systems. In another alternate embodiment, communication of the mileage information includes simply generating a written report containing the mileage information and sending it to the airline.

Once the airline receives the mileage information from the central controller 110 or casino, the airline mileage tracking system 118 bills the casino based on the miles purchased in step 1518. Sometime thereafter, as shown as step 1520, the casino pays the airline mileage tracking system 118 for the miles purchased. Finally, upon receiving payment, the airline mileage tracking system 118 adds the rewarded miles to each player's account in step 1522.

It is to be understood that several hardware and/or software arrangements are within the scope of the present invention. Thus, in an alternate embodiment, the functions of the table processing unit 216 are incorporated into each mileage counter 218. In another alternate embodiment, the mileage counters 218 accumulate players' wagers. These wagers are communicated to the central controller 110, which correlates the accumulated wagers to a reward of a number of frequent flyer miles.

Furthermore, it is to be understood that various alternate embodiments, which include variations on the above-described use of the mileage receipt 328, are within the scope of the present invention. For example, although the previously described embodiment included a printed mileage receipt 328, such a mileage receipt 328 is unnecessary. In one alternate embodiment, a player logs onto the system 100 by swiping a player tracking card through a card reader (not shown) in communication with each mileage counter 218. Because the player tracking card includes player identifying information, such as the player I.D. number 912, the central controller 110 is able to associate the miles awarded on a particular mileage counter 218 with a particular player I.D. number 912.

In some embodiments, when the dealer hits the reset button 320, the player I.D. number 912 and the miles awarded are sent to the central controller 110 where they are stored in the appropriate fields in the rewarded miles database 722 and the player database 724. Thus, a record is created in the player database 724 containing the received player I.D. number in field 912 and the assigned award tracking number in field 914. Similarly, a record is created in the rewarded miles database 722 having the assigned award tracking number in field 810 and the miles awarded in field 816.

In order for the player to assign the miles awarded 816 to a particular frequent flyer account 820, the player simply approaches the casino cage 114 and presents the player tracking card to a casino cashier. The casino cashier, in turn, swipes the player tracking card through a card reader (not shown) which transmits the player I.D. number stored on the card to the central controller 110. The central controller 110 accesses the player database 724 and locates the record containing the received player I.D. number in field 912. The central controller 110 reads the award tracking number from field 914 of that same record, and then locates the record in the rewarded miles database 722 having that same award tracking number in field 810. The miles awarded 816 have thus been located and may be assigned as described above with reference to steps 1120-1126 of FIG. 11.

As described with reference to FIGS. 13-15, the mileage receipt 328 is essentially a bearer paper, capable of being assigned to any account chosen by the bearer of the physical mileage receipt 328. Thus, the miles on a lost or stolen mileage receipt 328 can be used by anyone. In order to prevent the use of a mileage receipt by someone other than the deserving player, the mileage receipt in an alternate embodiment includes the player ID number printed thereon. Based on the player ID number printed on the mileage receipt, the cashier terminal prevents the associated awarded miles from being assigned to another player's account.

In another alternate embodiment, the dealer need not issue a mileage receipt at the end of a player's gaming session. Instead, the dealer issues a mileage receipt for each individual wager or play. Such individual mileage receipts are distributed by the dealer as an alternative to pressing one of the miles counter buttons 322, 324, 326.

In order to ensure the authenticity of the individual mileage receipts, certain information may be included thereon. Specifically, each mileage receipt may include the date of issuance, the number of the table issuing the mileage receipt, and the award tracking number. Either one or both of the date of issuance and the table number may be encrypted into the award tracking number. When the player attempts to assign the awarded miles to a frequent flyer account, the central controller 110 decrypts the award tracking number, thereby obtaining a decrypted date of issuance and table number. The decrypted date of issuance and table number are communicated to the cashier terminal 116 and the casino cashier. Only if the decrypted date of issuance and table number match those printed on the mileage receipt will the miles actually be awarded. It should be noted that the same type of cryptographic authentication may be employed with any of the mileage receipts described herein.

In another alternate embodiment, no mileage receipts are used at all. In such an embodiment, each player is issued a player tracking card having a unique player I.D. number stored thereon. When the player is issued a player tracking card, the player provides a frequent flyer account number, which is stored at the central controller 110. The account number is with the associated player's I.D. number. In operation, the player logs onto the system 100 by swiping the player tracking card through a card reader (not shown) coupled to the mileage counter 218. When the player decides to stop playing, the accumulated miles awarded and the player I.D. number are communicated to the central controller 110. The central controller 110, in turn, automatically assigns the awarded miles to the frequent flyer account previously provided. As will be appreciated by those skilled in the art, such an embodiment has the advantage of allowing each player to remain on the casino floor and to continue playing at a gaming table or gaming device, rather than walking to the casino cage 114 to assign the miles awarded.

Additionally, it is to be understood that the present invention maybe employed for tracking and accumulating reward points other than frequent flyer miles. For example, in an alternate embodiment, the dealer inputs into reward counters 218 a number of comp points or wagers that are correlated by the system 100 to comp points. The central controller 110 stores the reward points as it does frequent flyer miles in the previous embodiments. The reward points, rather than being transferred to an airline, are accumulated by the central controller 110. The casino, via the central controller 110, monitors each player's reward point total and, based on predetermined limits, offers qualifying players complimentary benefits based on their reward point total.

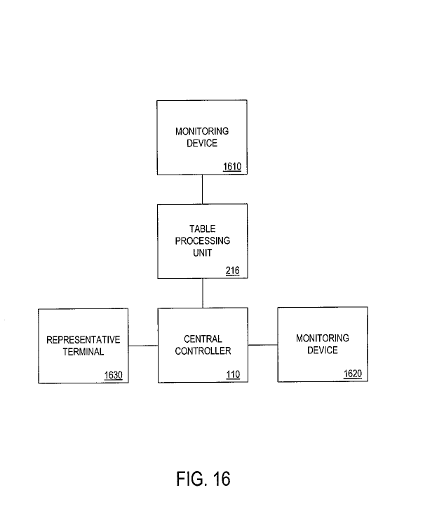

Referring now to FIG. 16, a system 1600 according to some embodiments of the present invention includes the central controller 110 in one or two-way communication via a communications link with one or more optional monitoring devices 1610, one or more table processing units 216, and/or one or more optional representative terminals 1630. In addition, one or more optional monitoring devices 1620 are in one or two-way communication with the table processing unit 216. The table processing unit 216 is thus able to relay information received from the monitoring device 1620 to the central controller 110. Also, the central controller 110 is able to relay information received from the monitoring devices 1610, 1620 to the representative terminal 1630. The monitoring devices 1610, 1620 and the representative terminal 1630 are described in detail below.

Any of the controller 110, the optional monitoring devices 1610, 1620, the table processing units 216, and the optional representative terminal 1630 may be physically proximate to any other device depicted in FIG. 16 or may be geographically remote from any other such device (e.g., in a different casino; in a different part of a city; in a different city, county, or state; in a different country).

According to some alternative embodiments of system 1600, one or more of the monitoring devices 1610, 1620 may be in direct communication with the representative terminal 1630. According to other alternative embodiments of system 1600, the representative terminal 1630 is in direct communication with one or more of the table processing units 216.

The various optional monitoring devices 1610, 1620 may aid or supplant the dealer in determining information about a player, information about one or more plays of a table game, or both. Such monitoring devices 1610, 1620 may include, but are not limited to, one or more of the following: a microphone, a camera, an electronic play tracking system, a playing card sensor, a pressure sensor, a light sensor, an infrared sensor, and/or a transmitter and sensor array system (e.g., antenna array) capable of determining the location of the transmitter.

For example, it is well known in the art to use one or more cameras to observe activity on a casino floor, including activity at gaming tables, in order to monitor players and casino personnel for cheating. According to some embodiments of the present invention, video content captured by one or more monitoring devices 1610, 1620 such as a camera with a view of one or more of the gaming tables 112, may be transmitted to the central controller 110. Such monitoring devices 1610, 1620 may monitor the gaming table from any number of angles and orientations. The video feed may be used by the controller 110, for example, to determine information about a play of a table game (e.g., a decision by a player, cards dealt, cards discarded, a wager) and/or about a player (e.g., a player's identity, a player's “body language”). in some alternative embodiments, video content may be transmitted to the representative terminal 1630 and/or to the table processing unit 216.

In another example, the monitoring devices 1610, 1620 may comprise one or more microphones. The monitoring device 1610, 1620 could then detect audio signals by a player, a dealer, a casino representative, or observer, in an area in which one or more of the gaming tables 112 are located. For example, a player might say “Hit”, “Stand”, “I busted again!”, “I bet ten”, or “I got the ace!” out loud. According to some embodiments, audio content from the monitoring devices 1610, 1620 may be transmitted to the central controller 110. The audio feed may be used by the central controller 110, for example, to determine information about a play of a table game (e.g., a decision by a player, cards dealt, cards discarded, a wager) and/or a player (e.g., a player's identity, a player's stated mood). In some alternative embodiments, such audio content may be transmitted to the representative terminal 1630 and/or to the table processing unit 216.

In some embodiments, the central controller 110 stores optional recognition software that may be used in conjunction with information received from monitoring devices 1610, 1620 for determining information about a player, information about one or more plays of a table game, or both. Such optional software, described further below, may provide functionality such as, for example: voice recognition, face identification, wager determination, and/or card recognition. In alternative embodiments, the recognition functionality may be provided by hardware and/or hardware in combination with software.

For example, in some embodiments the value or rank of a player's hand may be determined by transmitting the video feed from the monitoring device 1620 to the central controller 110. Central controller 110 may then use optional card recognition software stored, for example, in data storage device 720, to determine one or more of the cards in the player's hand.

To recognize cards, software executable by the central controller 110 may employ various techniques. In one example, the central controller 110 may store digitized images of each type of card, in various orientations in two or three dimensions. Central controller 110 may then compare images from camera feeds with the digitized images of various cards. Central controller 110 first searches for indications of cards. For instance, the software could search for rectangular patterns (in various orientations) in the images from the camera feed. Central controller 110 may then perform matrix operations on the rectangular images in order to translate the images into a fixed orientation (e.g., vertical or horizontal).

One or more color filters could be applied to the image. For instance, a color filter may remove a blue tinge from the image due to the nature of the ambient lighting in the casino. Central controller 110 then compares the translated patterns to stored images of cards. According to one embodiment, the card recognition software performs a pixel-by-pixel comparison of color in the respective images. When there is a close match between the image from the camera feed and the stored image (e.g., 85% or more of the pixels match to within a predetermined tolerance), central controller 110 may determine that the card in the player's hand is the same as the card corresponding to the stored digital image.

Central controller 110 may also determine when a player is playing multiple hands. For example, a player may elect to split a hand of two like cards, forming two new hands out of the single old hand. As a check to see whether a player has split or not, software of central controller 110 may determine whether a grouping of cards could be a valid single hand, rather than two or more separate hands. For example, if the software recognizes two “10s”, a queen, and an “8” in front of a player, then central controller 110 can determine that the cards constitute at least two separate hands, since any three of the four cards contained in a single hand would have caused the player to bust already, in which case he would not have received a fourth card. In this way, central controller 110 may recognize that cards associated with a player represent more than one hand, and therefore should be counted as cards in different hands rather than as cards of the same hand.

The central controller 110 may also determine the point value associated with each card. For example, the central controller 110 may store an indication of the point value associated with each card for each of various table games. In blackjack, for instance, a king is worth ten points, a “10” is worth ten points, a “9” is worth nine points, and so on. An ace is worth one or eleven points, depending on which is most beneficial to the player. After determining individual card point values, central controller 110 may tally the card point values in the player's hand in order to determine the total value of the player's hand. From the camera feed, central controller 110 is thus able to determine, for instance, when a player has a blackjack, consisting of an ace and a card with a value of ten points, for a total of twenty-one points.

Optional software may also allow central controller 110 to associate a particular hand in the camera's field of view with a particular player. In one embodiment, the field of view of the camera remains fixed, and one or more gaming tables falling within the camera's field of view also remain fixed. Therefore, a fixed area within any image captured by the camera corresponds to a fixed area on a gaming table below. For instance, the lower right hand corner of any image from a particular camera always corresponds to the first position on a specific gaming table. Therefore, the central controller 110 need only know where a player is sitting in order to associate a hand from the feed of an overhead camera with that player. If the central controller 110 knows, for example, that a player is sitting in the first position at the gaming table, then the central controller 110 can associate cards from the lower right hand corner of the video feed with that player.

The central controller 110 may determine where a particular player is sitting in various ways. For example, a player may insert a player tracking card into a tracking card reader (not shown) situated at the gaming table. The card reader may then transmit to the central controller 110 an indication that the player is sitting at a location that corresponds to the card reader. In another embodiment, the central controller 110 uses facial recognition software to recognize the player from a camera feed. Casinos already use facial recognition software to recognize known cheaters and known card counters. Such software may be used by central controller 110 to recognize any player for whom facial recognition information is maintained. Such information could be stored, for example, in player database 724.

In yet another embodiment, the player may wear a tag or other identifier that may be viewed by the monitoring device 1610, 1620. The tag may consist of unique patterns of color or symbols, a bar code, the player's name, a player tracking number, or other indicia that identifies the player. Such identifiers may be worn, for example, as a hat, a tie, a shirt, or other clothing, or a pin, tag or patch on a player's clothing. Central controller 110 may be programmed to recognize such identifiers and determine the corresponding player based on information stored, for example, in player database 724.

In some embodiments, the dealer, the pit boss, or other casino personnel reports where John is sitting to the central controller 110. In another embodiment, a casino representative may view an image of the player (e.g., captured from a video feed), and may identify the player to the central controller 110 based on personal experience, based on a comparison of the image with stored images in a database of casino customers, or based on a comparison of an identifier worn by the player with player information.

According to other alternative or additional embodiments, the monitoring device 1620 may comprise electronic game system for playing electronic versions of table games, such as those that provide video representations of playing cards or other game symbols. In such electronic versions, cards are randomized and video representations of the cards are distributed to the players by a processing unit. For example, PDS GAMING'S™ BONANZA BLACKJACK™ employs a DIGITAL CARD SYSTEM™. Players surround a dealer in a semi-circular arrangement, as is typical, but each player also has an electronic display screen for receiving cards electronically.

With an electronic version of a table game, the electronic game system may transmit to the central controller 110 an indication of any cards it deals to the player and to the dealer. The table may also transmit to the central controller 110 the amounts of any wagers made by the player, as well as whether the player has won or lost, split, doubled down, etc.

Another exemplary monitoring device 1610, 1620 useful for identifying cards in a player's hand is described in U.S. Pat. No. 6,126,166 issued to Raymond K. Lorson (“the Lorson patent”). The Lorson patent describes sensors embedded in the bottom portion of the card shoe. When the dealer deals a card, the card must pass over the sensors embedded in the bottom portion of the shoe. As the card passes over them, the sensors might count the number of pips on the card, or record variations of light and dark color as the card passes over. Software contained in the shoe or elsewhere can then associate the patterns of light and dark with individual cards, as each card has a unique pattern with respect to passage over the sensors.

As discussed above, information collected by the monitoring devices 1610, 1620, such as the ranking of a particular card may be transmitted to the central controller 110. Then, other information may be used to determine the person to whom the card is dealt. For example, software analyzing the feed from an overhead camera may discern when a card is dealt to someone by continuously comparing one frame of video footage to the next frame. If the software sees a difference in frames with respect to the area in front of a player, then it may conclude that a card has just been dealt to the player. The central controller 110, coupling the fact that a card has just been dealt to the player, with information that the ace of spades has just been dealt, may conclude that the ace of spades has just been dealt to John. Note that it may be far easier for an overhead camera to determine that a card has been dealt to John than it is for the camera to determine which card has been dealt to John. For this reason, an overhead camera may work in combination with sensors in the shoe, with the sensors identifying the card and the camera identifying the person to whom it is dealt.

In some embodiments, the central controller 110 need not know the exact cards that have been dealt to the player. For example, when a player busts, his cards are typically swept away by the dealer. Therefore, software analyzing the feed from an overhead camera would not necessarily have to recognize a player's card rankings to determine that the player has busted. Rather, it would just have to recognize that the dealer has swept away the player's cards. Sensors embedded in the table would also sense when the player's cards have been swept away. For example, the sensors could sense when the weight of the cards is no longer present, or they could sense the weight of the dealer's hands on the cards as the cards are swept away.

Monitoring devices 1610, 1620 comprising other types of sensors may be embedded underneath the surface of the gaming table. If cards are dealt face down, as they are in some variations of blackjack, then the sensors embedded in the table surface may function much like the sensors described above, which were embedded in the card shoe. The sensors may pick up patterns from the surfaces of playing cards as the cards pass over, and determine the card rankings. Furthermore, sensors may be embedded in the table at each player location, so that the same sensors could determine both the card ranks and the person to whom the cards are dealt.

If cards are dealt face-up, then it may be more difficult for sensors embedded in the table surface to discern card values. Embedded sensors may instead determine when a card has passed over by sensing the weight of the card, the air currents created by the passing card, or the heat of the card. Note that cards may have definitive heat signatures if they have been heated within the shoe, or if the dealer has held the cards. Then, information from sensors placed at each player location, and rank information derived from sensors in the shoe, may once again be correlated by the central controller 110, for example, to determine what cards a player has been dealt.

According to one embodiment, a monitoring device 1610, 1620 comprises a transmitter and array system that enables the movement of a dealer's hand to be tracked. For example, the dealer may wear one or more rings, bracelets, or gloves that emit electromagnetic signals. The signals may be detected by receivers preferably mounted along the perimeter of the gaming table. The sensors may thereby serve as an antenna array. Using optional software, the central controller 110 may analyze signals picked up by the array of sensors mounted along the edge of the table. By analyzing the relative times at which each sensor received the same reference signal from a dealer's transmitter, the central controller 110 may determine the spatial location of the transmitter at the time at which the signal was transmitted. Techniques for determining the location of a signal source based on signals received at antenna array elements are well known in the art.

Knowing the location of the transmitter as a function of time, the central controller 110 may deduce the player to whom a dealer has just dealt a card. For instance, if the central controller 110 tracks the transmitter as it follows a trajectory from the card shoe to the first position at the gaming table, then the central controller 110 may deduce that the dealer has just dealt a card to the player in the first position. Information gleaned from tracking the transmitter, coupled with other information received from other sensors, may be used by the central controller 110 to deduce the ranks or values of the cards dealt to each player.

According to various alternative or additional embodiments, it may be desirable for the central controller 110 to monitor the amounts of a player's bets. For example, the optional monitoring devices 1610, 1620 may comprise any of a number of well-known systems or devices to track a player's bet size, some of which are described in co-pending related U.S. patent application Ser. No. 09/597,801, “Gaming Token Having A Variable Value.”

According to another embodiment, monitoring devices 1610, 1620 comprise a camera attached to a gaming table. Such a camera preferably may be only slightly elevated above the surface of the gaming table. The elevation may range from being flush with the surface of the gaming table to being several feet above the surface. From its vantage point, the camera then looks out across the surface of the gaming table. An elevation serves to provide the camera with a side view of any chips being wagered by a player. A camera with a side view of the chips may better determine the amount of the player's wager. The video feed from the monitoring device 1610, 1620 might then be analyzed by optional pattern recognition software at the central controller 110. The software might then analyze the feed by looking, for example, for characteristic markings on the sides of chips, for characteristic chip colors, for characteristic shapes and lighting corresponding to a side view of gambling chips, and so on.

In another embodiment, monitoring devices 1610, 1620 may comprise a camera with a side view of the surface of the gaming table, and also having an elevation allowing a view of the top-surface features of cards, chips, or any other items or markings on the gaming table. For instance, the camera may be mounted several feet above the surface of the gaming table, and may look down at a 45-degree angle from the horizontal plane. From this exemplary vantage point, the camera may discern both side and top surface features. A camera so situated may participate in a card recognition process, as well as a chip recognition process.

In other embodiments, the monitoring devices 1610, 1620 comprise sensors embedded in the table that detect information related to the amount of a player's wager. For example, pressure sensors may sense the weight of a player's chips, thereby determining how many chips the player has wagered. Embedded sensors may also reflect a beam of light or other radiation off the chip. The sensor may then determine the color of the chip, and thereby the denomination of the chip, by analyzing the reflected light. In still another embodiment, chips contain embedded elements, such as magnets, that can be detected by sensors embedded in the gaming table.

According to various embodiments, a casino representative may be located at or near a gaming table 112, on the casino premises, or in a location remote from the casino premises (e.g., in a different part of the city or county; or in a different county, state, or country). Monitoring data from various monitoring devices 1610, 1620 may be transmitted to the representative terminal 1630 via the Internet, satellite, or via other well-known communication means. For example, the feeds from the various monitoring devices 1610, 1620 may be received at the central controller 110 and transmitted to a representative terminal 1630 and/or received directly from the monitoring devices 1610, 1620. The casino representative analyzes the feeds and records information about play of the table game (e.g., the actions of the player(s) and the dealer), for example, in play database 728 and/or session database 726.

In some embodiments, a single casino representative may monitor multiple players at the representative terminal 1630. Further, a casino representative may receive feeds from multiple monitoring devices 1610, 1620. The representative may have several monitors on which to view the multiple feeds.

The central controller 110, the dealer, and/or casino representative may also monitor the player and make assessments of the player's mood or level of enjoyment, based on the player's demeanor, body language, utterances, or any combination thereof, and may store indications of such assessments (e.g., “Player A thinks he is on an unlucky streak.”) in session database 726, for example.

Any of the information collected by the monitoring devices 1610, 1620 and/or determined by the central controller 110, a casino representative, and/or a dealer, may be stored, for example, in play database 728 and/or session database 726. Exemplary tracked information may include the cards dealt to the player, the cards dealt to the dealer, an amount wagered by the player, one or more decisions made by the player, amounts won or lost by the player, and so on.

According to some embodiments of the present invention, the central controller 110, the dealer, and/or casino representative may determine whether to award reward points (e.g., frequent flyer miles) and/or an amount of reward points to award to the player based on information about the player's actions, game results, gaming history, dealer actions, assessments of the player's state of mind or enjoyment of the table game, or any combination thereof. For example, the casino representative may compare tracked information with award criteria as in example award criteria database 730.

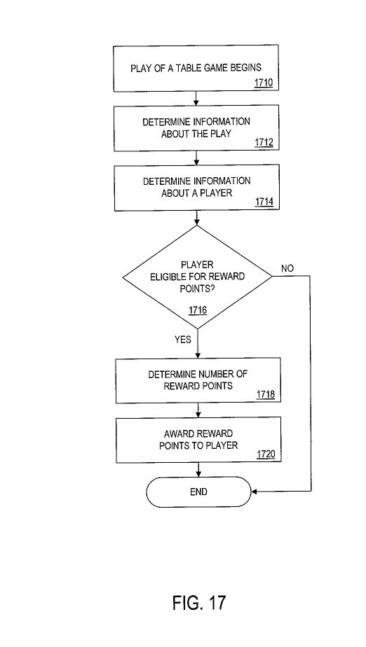

Referring to FIG. 17, a flow chart is depicted that represents some embodiments of the present invention that may be performed by a dealer, a casino representative, the table processing unit 216, the cashier terminal 116, and/or the central controller 110. It must be understood that the particular arrangement of elements in the flow chart of FIG. 17, as well as the order of example steps of various methods discussed herein, is not meant to imply a fixed order, sequence, and/or timing to the steps; embodiments of the present invention can be practiced in any order, sequence, and/or timing that is practicable.

In general terms and referring to FIG. 17, the method steps of some embodiments of the present invention may be summarized as follows. In step 1710, a play of a table game by a player begins. In step 1712, information about the play of the table game is determined. In step 1714, information about the player is determined. In step 1716, it is determined if the player should receive reward points. In step 1718, a number of reward points is determined. In 1720, the reward points are awarded to the player.

Note that not all of these six steps are required to perform the method of the present invention, and that additional and/or alternative steps are also discussed below. Also note that the above general steps represent features of only some of the embodiments of the present invention and that they may be combined and/or subdivided in any number of different ways so that the method includes more or less actual steps. For example, in some embodiments additional steps may be added to update and maintain the databases described above, but it is not necessary to use the above-described databases in all embodiments of the invention. In other words, the methods of the present invention may contain any number of steps that are practicable to implement the processes described herein. The methods of the present invention are now discussed in detail.

With reference to FIG. 17, in step 1710 a play of a table game by a player begins. For example, the player places a wager, and/or a hand of cards is dealt to the player. In some embodiments, as in step 1210 of FIG. 12A, a dealer deals cards to the player. In other embodiments, electronic representations of cards are displayed to the player in response to, for example, a control signal from a dealer, a control signal from the player, or receipt of an indication of a wager by the player.

In step 1712, information about the play of the table game is determined. In some embodiments, it is determined whether the player won or lost. Of course, various types of information may be determined about the play, including, but not limited to: the type of table game; one or more wagers made by the player; one or more cards received by the player; one or more hands held by the player; one or more cards discarded by the player; one or more cards received by the dealer; one or more hands held by the dealer, one or more cards discarded by the dealer; a rank of a hand held by the player; a rank of a hand held by the dealer; one or more decisions made by the player (e.g., “stand”, “hit”, “insurance”); one or more decisions made by a different player; a point total of the player; a point total of the dealer; a point total of a different player; a number of cards received by the player; a number of cards received by the dealer; a number of cards received by a different player; whether the player won, lost, or tied (e.g., “push”, “draw”) the play; how the player lost (e.g., “bust”, dealer had higher point total, a different player had a higher-ranking hand); how the player won (e.g., dealer went “bust”, player had higher point total); an amount won by the player; an amount lost by the player. Optionally, in some embodiments, the end of the play of the table game by the player is determined.

Information about the play of the table game may be determined in various ways, some of which are described herein. In some embodiments, the dealer or other casino representative determines information about the play of the table game, such as, for example, whether the player has won, lost, or tied. In other embodiments, the controller 110 determines information about the play of the table game based on information received from the dealer or other casino representative, and/or based on information received from the optional monitoring devices 1610, 1620. In some embodiments, information is received by the controller 110 and stored in play database 728. Information about the play of the table game may then be retrieved by the dealer, controller 110, and/or the table processing unit 116.

In step 1714, information about the player may be determined. Such information may include, but is not limited to: personal information; demographic information; financial information; gaming history; and/or information about the mood of the player, the player's behavior, body language, demeanor, or utterances. For example, information about the player may be retrieved by a casino representative, the controller 110, and/or the table processing unit 116 from player database 724 based on the player ID number 912. In some embodiments, information about the player's gaming history may be retrieved from session database 726, for example, based on the player ID number 912. In some embodiments, information about the player may be determined based on information received from the dealer or other casino representative, and/or based on information received from the optional monitoring devices 1610, 1620.

In step 1716, it is determined whether the player should receive an award. If the player should not receive an award, the process ends.

In some embodiments, the determination is made based on whether the information about the play satisfies at least one of various rules, conditions, or criteria that may be established, such as the criteria stored in award criteria database 730. For example, the player could receive an award if the player lost the play of the table game. Of course, as discussed above, awards may be given to all players, including players who win, players who do not win, players who lose, players who tie, or any combination of such players. For example, a player could receive an award simply for playing the table game.

In another example, the criteria may be that the player “stands” during the play and also loses. In another example, the player may be eligible for an award if the player achieved a particular point total during the play. In another example, the player may receive an award if the player made a particular decision (e.g., “hit,” “stand,” “double down,” “surrender,” “early surrender,” “late surrender,” “split,” “take insurance”) during the play. In some cases, the casino may want to reward a player for making one or more decisions that go against an optimal or generally-accepted strategy for the particular table game. In another example, the player may be eligible for an award if the player makes decisions at a predetermined rate. The casino may want to reward the player in order to encourage a rapid rate of play. In another example, the player could be eligible for an award if the player busted during the play. In some embodiments, the determination is made based only on information about the play, and is independent of any information about the player, such as the player's gaming history prior to the play.

Of course, other rules, conditions, or criteria may be used in determining whether to award a player. An award may be granted based on, for example, at least one of the following: whether the player has busted after drawing to a hand with a point total within a certain range (e.g., twelve to thirteen); whether the player has been one of only n losers at the gaming table, where n is a natural number; and whether the player busted after a player acting before him made a “hit” decision (e.g., an unskilled tourist went against accepted strategy and requested a “hit”), and received a card that would have helped him.

In other embodiments, the determination is made based on whether the information about the player satisfies at least one of various rules, conditions, or criteria that may be established. In some embodiments, the player may receive an award based on the player's identity and/or demographic information. For example, the player may be of a demographic group that the casino is particularly interested in attracting and/or retaining as players.

In other embodiments, the player may receive an award based on the player's gaming activity, such as, for example, whether the player has: lost a predetermined number of plays in a row; won a predetermined number of plays in a row; tied a predetermined number of plays in a row; lost a predetermined number of plays within a particular period of time; won a predetermined number of plays within a particular period of time; tied a predetermined number of plays within a particular period of time; lost a predetermined percentage of plays; won a predetermined percentage of plays; and/or tied a predetermined percentage of plays.

In another example, a player could be eligible for an award if the player has: wagered a predetermined amount of funds (or an amount within a particular range); lost a predetermined amount (or an amount within a particular range); and/or won a predetermined amount (or an amount within a particular range).

In another example, a player may begin a gaming session with an initial amount of available funds, which may be available for wagering from any of various well-known sources, such as chips, cash, credit, credit card account, and/or debit card account. The player could be eligible for an award if the player has, for example: wagered a predetermined percentage of initially-available funds (or a percentage within a particular range) (e.g., the player wagered 40% of his initially-available $100 in chips); lost a predetermined percentage of initially-available funds (or a percentage within a particular range); and/or won a predetermined percentage of initially-available funds (or a percentage within a particular range).

Note that because the information about the player's gaming history may include information about one or more prior plays of a table game, any of the criteria described above with respect to information about the play may be used in determining whether to provide an award based on information about prior plays by the player. For example, the player may be eligible for an award if the player lost after achieving a particular point total in a prior play, or if the player busted.

In some embodiments, the determination is made based on only information about the player, and is independent of any information about the play. For example, the determination may be based on the player's gaming history prior to the play.

Of course, in some embodiments the determination is made based on both information about the play and information about the player. For example, the player may receive an award if the player lost the play and also has won an amount below a predetermined threshold in a given gaming session. In another example, the player may receive an award if the player lost the play and also lost a predetermined number of prior plays.

Although a dealer is described as making many of the determinations described herein, it will be understood by those of skill in the art that such determinations may be made, for example, by the dealer (or other casino representative), the table processing unit 216, and/or the central controller 110. For example, the controller 110 may determine whether to provide an award by comparing information about the player and/or information about the play to see if the information meets one or more conditions, such as, for example, criteria stored in award criteria database 730.

If the player should receive an award, a number of reward points is determined in step 1718. In some embodiments, the number of reward points is based on information about the play and/or information about the player. For example, the number of reward points may be based on a wager by the player, as described above with respect to step 1216 of FIG. 12A. In another example, the number of reward points maybe based on an indication that the player does not want another play of the table game. In another example, the number of reward points may be based on the amount lost by the player in a session. In a further example, the number of reward points could be based on the amount the player is down for the gaming session, or on the percentage of the initially-available balance that the player has lost. In other embodiments, the number of reward points may be independent of any information about the play and/or information about the player. For example, the casino may decide that all eligible players will receive 100 reward points.

In other embodiments, an eligible player may receive a number of reward points equal to a predetermined number (e.g., 100) that is adjusted based on information about the play and/or information about the player. For example, the casino may provide a default amount of 100 reward points to all eligible players, but adjusts the default amount based on the information (e.g., subtracts twenty-five points if the player won the play; adds thirty points if the player has lost three plays in a row).

In some embodiments, each satisfied criterion (or set of satisfied criteria) is associated with a number of reward points. For example, as depicted in award criteria database 730, a player who meets the criterion of having lost his last play may receive a corresponding number of 100 reward points.

In step 1720, the reward points are awarded to the player. In some embodiments, a reward point counter, such as mileage counter 218, is incremented. In other embodiments, an awarded number of reward points is associated with an identifier, such as tracking number 810. The award identifier may be given or displayed to the player. For example, the controller 110 may associate an award tracking number 810 with the number of reward points and store the award information in rewarded miles database 722. In other embodiments, an awarded number of reward points is associated with the player. For example, the controller 110 may associate an award tracking number 810 to the number of reward points and also associate the award tracking number 810 to the player by storing an indication of the award tracking number in an appropriate player record of player database 724. In another example, the controller may associate the number of reward points with the player by storing an indication of the number of reward points in an appropriate player record of player database 724. In some embodiments, the player receives an indication of the award, such as a receipt.

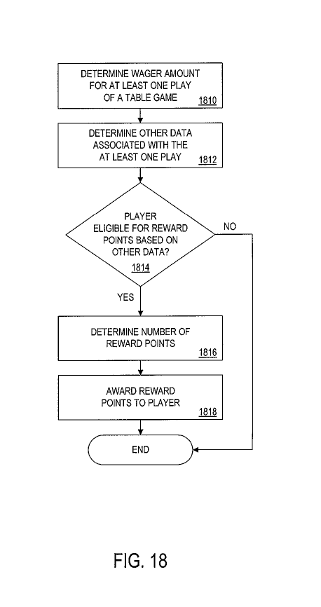

Referring to FIG. 18, a flow chart is depicted that represents some alternative embodiments of the present invention that may be performed by a dealer, a casino representative, the table processing unit 216, the cashier terminal 116, and/or the central controller 110. It must be understood that the particular arrangement of elements in the flow chart of FIG. 18, as well as the order of example steps of various methods discussed herein, is not meant to imply a fixed order, sequence, and/or timing to the steps; embodiments of the present invention can be practiced in any order, sequence, and/or timing that is practicable.

In general terms and referring to FIG. 18, the method steps of some alternative embodiments of the present invention may be summarized as follows. In step 1810, a wager amount associated with at least one play of the table game is determined. For example, a wager amount on the last play of a table game, on any prior play, or on more than one prior play is determined based on stored information and/or information known to the dealer or casino representative, as described above. In some embodiments, the wager amount is associated with a play tracked in play database 728 and/or with a gaming session tracked in session database 726.

In step 1812, other information associated with the at least one play is determined. Such information may include any of the information about the play of a table game and/or information about the player as described herein, but is not meant to include information about wager amounts. In step 1814, it is determined whether the player should receive an award based on the non-wager information. For example, it may be determined that a player is eligible for an award if the player lost the last play, or if the player stood and lost. Of course, other rules, conditions, or criteria may be applied, such as criteria stored in example award criteria database 730. If the player should not receive an award, the process ends. In any case, the determination of whether to provide the award is independent of how much the player wagered on the play or how much the player has wagered on any past plays.

If the player should receive an award, a number of reward points is determined in step 1816. The number of reward points may be based on any information about a play of a table game and/or information about the player, including wager-related information, as discussed above with respect to step 1750 of FIG. 17. Finally, in step 1818, the reward points are awarded to the player in any of the various ways described herein.

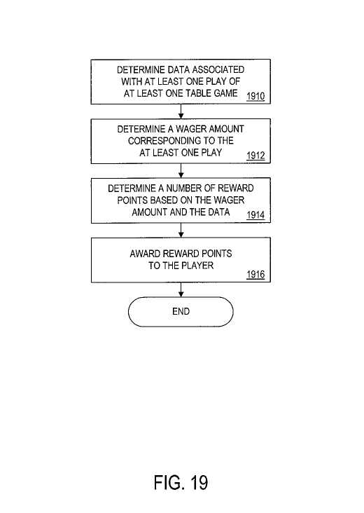

Referring to FIG. 19, a flow chart is depicted that represents some alternative embodiments of the present invention that may be performed by a dealer, a casino representative, the table processing unit 216, the cashier terminal 116, and/or the central controller 110. It must be understood that the particular arrangement of elements in the flow chart of FIG. 19, as well as the order of example steps of various methods discussed herein, is not meant to imply a fixed order, sequence, and/or timing to the steps; embodiments of the present invention can be practiced in any order, sequence, and/or timing that is practicable.

In general terms and referring to FIG. 19, the method steps of some alternative embodiments of the present invention may be summarized as follows. In step 1910, information associated with the at least one play of a table game is determined. Such information may include any of the information about the play of a table game and/or information about a player as described herein, but is not meant to include information about wagers or wager amounts. In step 1912, a wager amount associated with the at least one play of the table game is determined. As described above with respect to step 1810 of FIG. 18, the wager amount may correspond to the last play of a table game, any prior play, or more than one prior play based on stored information and/or information known to the dealer or casino representative. For example, the wager amount may be associated with a play tracked in play database 728 or with a gaming session tracked in session database 726.

In step 1916, a number of reward points is determined. In these alternative embodiments, the number of reward points is based on both wager-related information and non-wager-related information, such as data about the at least one play of a table game and/or information about the player, as discussed above with respect to steps 1740 and 1750 of FIG. 17. Finally, in step 1918, the reward points are awarded to the player in any of the various ways described herein.

In some alternative embodiments, the mileage counter 218 may contain an optional “undo” button (not shown), or other similarly-identified button that can reverse the effects of pressing a reset button 320. For example, a dealer might mistakenly press the reset button 320, causing the mileage counter 218 to clear. The player may protest, at which time the dealer may hit the undo button. The undo button may cause the mileage counter 218 to once again display the player's awarded miles. When the dealer presses the undo button, the mileage counter 218 may also transmit to the table processing unit 216 a signal not to print out a receipt for the player, and/or not to send a signal to the central controller 110.

In some alternative embodiments, the mileage counter 218 periodically transmits the number of miles awarded to the table processing unit 216. The mileage counter 218 may transmit with or without input from the dealer or from other casino personnel. For example, every 0.1 seconds the mileage counter 218 may transmit the number of miles awarded to the table processing unit 216. The table processing unit 216 may store the number of miles awarded in memory 416 in association with an identifier associated with the player. In some embodiments, when the dealer hits the reset button 220, the mileage counter 218 need not transmit the number of miles awarded to the table processing unit 216, since the table processing unit 216 has received an update of the number of miles awarded within the last 0.1 seconds.

In other alternative embodiments, the dealer may periodically press an optional “update” button (not shown) on the mileage counter 218 to cause the mileage counter 218 to transmit the number of miles awarded to the table processing unit 216 without resetting the mileage counter 218. In another example, after receiving an update of the number of miles awarded, the table processing unit 216 transmits the number of miles awarded immediately to the central controller 110. In such a case, the table processing unit 216 need not store an indication of the number of miles awarded longer than is necessary to transmit to the central controller 110.

In some embodiments where various player and dealer actions may be tracked automatically, such as through use of the SAFEJACK™ system by MIKOHN GAMING™, the system of the present invention need not include the mileage counter 218, since there is not necessarily a need for the dealer to type in the amount of a player's wager, and/or the amount of miles to be awarded. Similarly, various embodiments of the present invention may not include a table processing unit 216. For instance, if players are awarded miles automatically, there may be no need to receive a dealer identification card at a table processing unit 216. Because it is no longer up to the dealer to award miles, there may not be a need to make sure the dealer is awarding the proper number of miles.

Note that it is not critical that tracking software be 100% accurate in determining the cards received by a player, the decisions made by the player, the amounts wagered by the player, and so on. This is especially true if the player will not see the amounts of his awards until after the end of a session. In many embodiments, if the tracking software cannot accurately determine the number of miles to be awarded the player, then the software may give the player the benefit of any doubt. For instance, if the software could not tell whether the player had four or five casino chips in the bet he made, then the software may award miles to the player as if he had bet with five chips.

According to various alternative and additional embodiments, the receipt may provide the player with a summary of his playing session. For instance, the receipt may say, “You lost 40 hands and received 25 frequent flyer miles for every hand you lost, giving you a total of 1000 miles for the session.” The receipt may further provide a record of each hand the player has played. For example, the record may include at least one of:

the player's original wager;

any subsequent wagers made by the player (e.g., wagers for splitting, doubling down, or insurance);

the original cards in the player's hand;

additional cards the player received;

the original card shown in the dealer's hand;

additional cards the dealer received;

the result of the hand (e.g., win, loss, tie, blackjack, bust, surrender);

the amount paid to the player;

the amount lost by the player; and

the number of miles awarded for each hand.

The record of the player's session, in some embodiments, may be tracked using cameras and/or other monitoring devices as described above, which may keep track of the cards dealt to the player and to the dealer, of the amounts wagered by the player, and so on.

In some embodiments, the receipt does not include the hands for which the player received miles. For example, the player might have received miles for losing hands, so reminding the player of losses may be disappointing for the player. Instead, a receipt might say, “You played for two hours and won 1000 frequent flyer miles. Congratulations!”

In other various embodiments, a player may be informed of the number of miles he has been awarded by inserting his player tracking card into a kiosk. The kiosk may then query the central controller 110 based on the player tracking card and receive information about the player from the central controller 110. The kiosk may then display the number of miles awarded, and any other information about the player's session, or about prior sessions. The kiosk may also have a printer with which to print out information about playing session(s) of the player, or with which to print out a mileage receipt.

A player might also insert his tracking card into a slot machine in order to see the number of miles he has been awarded. The slot machine may then display the miles on a display screen for the outcomes, or on the display screen for the tracking card reader. A player may also be provided with an indication of the number of miles he has received: on the hotel bill he receives from the casino; on a receipt for the purchase of a meal, show ticket, or other product; on the television of his hotel room (e.g., on a special channel); or on a Web site hosted by the central controller I 10 or a related party.

As discussed above, the mileage counter 218 may display to the player the amount of frequent flyer miles he has been awarded following every game. However, the display need not be made following every play of the table game, or even following every event in which the player has won miles (e.g., every player loss). Instead, the player may be shown the number of miles he has been awarded under any of the various following circumstances, including, for example, when:

the player has finished a playing session;

the total number of miles awarded to the player for the session has exceeded a certain threshold (e.g., 5000, 10000, etc.);

the player has asked to see the number of miles he has been awarded;

a new dealer has come to the table;

the cards are being shuffled;

the table is receiving new chips;

the player has lost a predetermined number of hands in a row, or experienced a predetermined number or sequence of events(e.g., the player may be shown the number of miles he has been awarded after having busted three hands in a row, or after having lost with a 20, then busted, then split 10's and lost on both hands); and

the total number of miles awarded to the player for a particular time period has exceeded a certain threshold.

Exemplary time periods include: the day, the duration of the player's stay at the casino, the total amount of time the player has spent playing blackjack (regardless of the number of sessions he has played), the total amount of time the player has spent playing table games, and so on.

Note that when a player is shown the number of miles he has been awarded, the number he is shown may be the number of miles he has been awarded, for example, for the last hand, for the last ten hands, for the session, or since coming to the casino. Other numbers of miles maybe provided as appropriate.

Various embodiments of the present invention provide the advantage that the rewards tend to provide an incentive for the player to come back at a later date. The casino is more willing to spend one hundred dollars on frequent flyer miles if it will bring players back to the casino to gamble more. For example, the casino could offer restricted frequent flyer miles whereby the player is rewarded with even larger amounts of miles. These restricted frequent flyer miles would only be good for return trips to that gambling location (e.g., Las Vegas), thereby increasing the likelihood of future business from that player.

Although the present invention has been described in terms of certain preferred embodiments, other embodiments that are apparent to those of ordinary skill in the art are also intended to be within the scope of the present invention. Accordingly, the scope of the present invention is intended to be limited only by the claims appended hereto.

What is claimed is:

1. A method comprising:
determining a wager amount corresponding to at least one play of at least one table game by a player;
determining data associated with the at least one play, in which the data does not indicate the wager amount;
determining whether the player is eligible for reward points based on the data;
determining a number of reward points; and
awarding the number of reward points to the player if the player is eligible for reward points.

2. The method of claim 1, in which determining the data comprises:
determining if the player busted.

3. The method of claim 2, in which determining the data further comprises:
determining if the player busted after drawing to a hand having a point total that is not less than a predetermined point total.

4. The method of claim 2, in which determining the data further comprises:
determining if the player busted after drawing to a hand having a point total that is not greater than a predetermined point total.

5. The method of claim 1, in which determining the data comprises:
receiving monitoring data from at least one monitoring device; and
determining the data based on the monitoring data.

6. The method of claim 5, in which the monitoring data includes an indication of at least one card.

7. The method of claim 1, in which determining the data comprises:
receiving video content from at least one camera.

8. The method of claim 7, in which the video content includes an indication of at least one card.

9. The method of claim 7, in which the video content includes an indication of a wager amount.

10. The method of claim 1, in which determining the data comprises:
receiving audio content from at least one microphone.

11. The method of claim 10, in which the audio content includes an indication of at least one card.

12. The method of claim 10, in which the audio content includes an indication of a wager amount.

13. The method of claim 10, in which the audio content includes an indication of at least one of:
a perceived mood of the player;
whether the player communicates disappointment;
whether the player communicates frustration;
whether the player communicates that the player is in bad spirits;
whether the player communicates a desire for a second play of the table game; and
whether the player communicates an intent to play a second play of the table game.

14. The method of claim 1, in which determining the data comprises:
receiving sensor data from at least one sensor at a gaming table.

15. The method of claim 14, in which the sensor data includes an indication of at least one card.

16. The method of claim 14, in which the sensor data includes an indication of a wager amount.

17. The method of claim 1, in which determining the data comprises:
receiving sensor data from at least one pressure sensor.

18. The method of claim 1, in which determining the data comprises:
receiving sensor data from at least one sensor in a card shoe.

19. The method of claim 1, in which determining the data comprises:
receiving sensor data from at least one light sensor.

20. The method of claim 1, in which determining the data comprises:
receiving the data from an electronic play tracking system.

21. The method of claim 1, in which determining the data comprises:
receiving array data from a sensor array system.

22. The method of claim 21, in which the array data includes an indication of a position of a transmitter.

23. The method of claim 22, in which the transmitter is wearable.

24. The method of claim 22, in which the transmitter is worn by a dealer.

25. The method of claim 22, in which the position corresponds to a hand of a dealer.

26. The method of claim 22, in which a ring comprises the transmitter.

27. The method of claim 22, in which a bracelet comprises the transmitter.

28. The method of claim 22, in which a glove comprises the transmitter.

29. The method of claim 1,
in which determining the data comprises:
determining an outcome of the at least one play; and
in which determining whether the player is eligible for reward points comprises:
determining whether the player is eligible for reward points based on the outcome.

30. The method of 29, in which determining whether the player is eligible for reward points comprises:
determining that the player is eligible for reward points if the outcome is not a winning outcome.

30. The method of 29, in which determining whether the player is eligible for reward points comprises:
determining that the player is eligible for reward points if the outcome is a winning outcome.

31. The method of claim 1, in which determining the data comprises:
determining at least one play that the player lost; and
determining whether the player achieved at least a predetermined number of points in the at least one play that the player lost.

32. The method of claim 1, in which determining the data comprises:
determining at least one play that the player lost; and
determining whether the player stood in the at least one play that the player lost.

33. The method of claim 1, in which determining the data comprises:
determining a number of plays lost by the player; and
determining whether the number of plays lost by the player is not less than a predetermined number.

34. The method of claim 1, in which determining the data comprises:
determining a number of consecutive plays lost by the player; and
determining whether the number of consecutive plays lost by the player is not less than a predetermined number.

35. The method of claim 1, in which determining the data comprises:
determining a number of plays by the player;
determining a number of losing plays by the player;
determining a loss percentage based on the number of plays played by the player and the number of losing plays by the player; and
determining whether the loss percentage is not less than a predetermined percentage.

36. The method of claim 1,
in which determining the data comprises:
determining a prior balance associated with the player;
determining a current balance associated with the player; and
in which determining whether the player is eligible for reward points comprises:
determining that the player is eligible if the second balance is not greater than the first balance.

37. The method of claim 1, in which determining the data comprises:
determining an amount of funds lost by the player.

38. The method of claim 37, in which determining the data further comprises:
determining whether the amount of funds lost by the player was lost during a predetermined period of time.

39. The method of claim 38, in which the predetermined period of time corresponds to a predetermined number of minutes.

40. The method of claim 38, in which the predetermined period of time corresponds to at least one calendar day.

41. The method of claim 38, in which the predetermined period of time corresponds to a time at which the player commenced the at least one play.

42. The method of claim 37, in which determining the data further comprises:
determining whether the amount of funds lost by the player is not less than a predetermined minimum loss amount.

43. The method of claim 37, in which determining the data further comprises:
determining whether the amount of funds lost by the player is not greater than a predetermined maximum loss amount.

44. The method of claim 37, in which determining the amount of funds lost by the player comprises:
determining an amount of finds lost by the player since commencing the at least one play.

45. The method of claim 1, in which determining the data comprises:
determining a first amount of funds available to the player at a first time;
determining a second amount of finds available to the player at a second time;
determining a difference between the first amount and the second amount;
determining a loss percentage based on the difference and the first amount of funds; and
determining whether the loss percentage is not less than a predetermined percentage.

46. The method of claim 45, in which the first time corresponds to when the player commenced the at least one play.

47. The method of claim 1, in which determining the data comprises:
determining a rate of play associated with the player; and
determining whether the rate of play is not less than a predetermined minimum rate of play.

48. The method of claim 47, in which the predetermined minimum rate of play corresponds to a predetermined number of plays per a predetermined period of time.

49. The method of claim 47, in which the predetermined minimum rate of play corresponds to a predetermined number of decisions per a predetermined period of time.

50. The method of claim 1, in which determining the data comprises:
determining at least one card that is held by the player during the at least one play;
determining at least one card that is received by a second player; and
determining a potential outcome based on the at least one card that is held by the player and the at least one card that is received by the second player.

51. The method of claim 50, further comprising:
determining an outcome of the at least one play; and
awarding a first payout to the player based on the outcome,
in which determining the data further comprises:
determining a second payout based on the potential outcome; and
determining whether the second payout is greater than the first payout.

52. The method of claim 1, in which determining whether the player is eligible for reward points comprises:
determining whether the player is eligible for reward points based on the data and the wager amount.

53. The method of claim 1, in which determining the number of reward points comprises:
determining the number of reward points based on the wager amount.

54. The method of claim 1, in which determining the number of reward points comprises:
determining the number of reward points based on the data.

55. The method of claim 1, in which determining the number of reward points comprises:
determining the number of reward points based on the wager amount and the data.

56. The method of claim 1, in which awarding comprises:
determining an end of the at least one play; and
awarding the number of reward points in response to determining the end of the at least one play.

57. The method of claim 1, in which determining the number of reward points comprises:
determining the number of reward points based on the data.

58. The method of claim 1, in which awarding comprises:
determining a reward point balance associated with the player; and
increasing the reward point balance based on the number of reward points.

59. The method of claim 1, in which awarding comprises:
transmitting a signal to a reward counter, the signal being operative with the reward point counter to increase a reward point balance.

60. The method of claim 59, in which transmitting comprises:
activating a button.

61. The method of claim 1, in which awarding comprises:
transmitting a signal to a controller, the signal being operative with the controller to increase a reward point balance.

62. The method of claim 61, in which transmitting comprises:
activating a button.

63. The method of claim 1, in which the at least one play comprises a play of a first table game and a play of a second table game.

64. The method of claim 1, in which each of the at least one plays is of only one table game.

65. The method of claim 1, in which the at least one play is associated with a plurality of gaming sessions.

66. The method of claim 1, in which the at least one play comprises a first play during a first gaming session and a second play during a second gaming session that is after the first gaming session.

67. The method of claim 1, in which each at least one play is associated with a gaming session.

68. The method of claim 1, in which each at least one play is associated with a particular gaming table.

69. The method of claim 1, in which the at least one play comprises a first play at a first gaming table and a second play at a second gaming table.

70. The method of claim 1, in which the data includes an indication of at least one of:
an amount won by the player, and an amount lost by the player.

71. The method of claim 1, in which the data includes an indication of at least one of:
a hand held by the player,
a hand held by a dealer,
a card held by the player,
a card held by the dealer, and
a card held by a second player.

72. The method of claim 1, in which the data includes an indication of at least one decision by the player.

73. The method of claim 72, in which the at least one decision includes at least one of:
a decision to wager,
a decision to hit,
a decision to stand,
a decision to double down,
a decision to surrender,
a decision to take insurance,
a decision to split,
a decision to early surrender, and
a decision to late surrender.

74. The method of claim 72, in which the at least one decision is contrary to a predetermined strategy associated with the table game.

75. The method of claim 1, in which the data includes an indication of at least one of:
a point total of the player, and
a point total of a dealer.

76. The method of claim 1, in which the data includes an indication of an outcome of the at least one play.

77. The method of claim 1, in which the data includes an indication of at least one of:
a number of plays won by the player,
a number of plays lost by the player, and
a number of plays tied by the player.

78. The method of claim 1, in which the data includes an indication of at least one of:
whether the player busted, and
whether the player tied a dealer.

79. The method of claim 1, in which the data includes an indication of at least one of:
a perceived mood of the player,
whether the player communicates disappointment,
whether the player communicates frustration,
whether the player communicates that the player is in bad spirits,
whether the player communicates a desire for a second play of the table game, and
whether the player communicates an intent to play a second play of the table game.

80. The method of claim 1, in which the reward points comprise frequent flyer miles.

81. The method of claim 1, in which the reward points comprise frequent shopper points.

82. The method of claim 1, in which the reward points comprise points redeemable for a purchase.

83. The method of claim 1, in which the reward points comprise points redeemable for a discount on a purchase.

84. The method of claim 1, in which the reward points comprise telephone minutes.

85. The method of claim 1, further comprising:
providing a mileage receipt to the player, the mileage receipt including an award tracking number, the award tracking number uniquely identifying the mileage receipt;
receiving the mileage receipt from the player;
verifying authenticity of the mileage receipt;
receiving information that indicates a reward points account; and
crediting, to the indicated reward points account, reward points represented by the mileage receipt.

86. A method comprising:
determining data associated with at least one play of at least one table game by a player;
determining a wager amount corresponding to the at least one play;
determining a number of reward points based on the wager amount and the data; and
awarding the number of reward points to the player.

87. The method of claim 86, in which awarding comprises:
determining whether the player is eligible for reward points based on the data; and
awarding the number of reward points to the player if the player is eligible for reward points.

88. The method of claim 86, in which awarding comprises:
determining whether the player is eligible for reward points based on the wager; and
awarding the number of reward points to the player if the player is eligible for reward points.

89. The method of claim 86, in which determining the data comprises:
determining an outcome of the play.

90. The method of claim 89, in which awarding comprises:
awarding the number of reward points to the player based on the outcome.

91. The method of claim 89, in which awarding comprises:
awarding the number of reward points to the player if the outcome is not a winning outcome.

92. The method of claim 89, in which awarding comprises:
awarding the number of reward points to the player if the outcome is a winning outcome.

93 A method comprising:
determining data corresponding to a gaming session associated with a player,
in which the gaming session comprises a play of a table game;
determining a probability of the player terminating the gaming session based on the data and at least one predetermined rule; and
providing a number of reward points to the player if the probability is greater than a predetermined probability.

94. The method of claim 93, further comprising:
receiving a wager from the player for the play;
determining an outcome of the play; and
providing a payout to the player based on the outcome.

95. The method of claim 93, in which the data includes an indication of at least one of:
an amount won by the player, and
an amount lost by the player.

96. The method of claim 93, in which the data includes an indication of at least one of:
a hand held by the player,
a hand held by a dealer,
a card held by the player,
a card held by the dealer, and
a card held by a second player.

97. The method of claim 93, in which the data includes an indication of at least one decision by the player.

98. The method of claim 97, in which the at least one decision includes at least one of:
a decision to wager,
a decision to hit,
a decision to stand,
a decision to double down,
a decision to surrender,
a decision to take insurance,
a decision to split,
a decision to early surrender, and
a decision to late surrender.

99. The method of claim 93, in which the data includes an indication of at least one of:
a point total of the player, and
a point total of a dealer.

100. The method of claim 93, in which the data includes an indication of an outcome of the at least one play.

101. The method of claim 93, in which the data includes an indication of at least one of:
a number of plays won by the player,
a number of plays lost by the player, and
a number of plays tied by the player.

102. The method of claim 93, in which the data includes an indication of at least one of:
whether the player busted, and
whether the player tied a dealer.

103. The method of claim 93, in which the data includes an indication of at least one of:
perceived mood of the player,
whether the player communicates disappointment,
whether the player communicates frustration,
whether the player communicates that the player is in bad spirits,
whether the player communicates a desire for a second play of the table game, and
whether the player communicates an intent to play a second play of the table game.

104. The method of claim 93, further comprising:
determining the number of reward points based on the data.

105. A method comprising:
receiving an identifier that identifies a player;
receiving an indication of a wager by the player;
determining an outcome of a first play of a table game;
providing an indication of the outcome to the player;
determining data corresponding to the first play, the first data indicating at least one of:
an amount lost by the player,
a hand of the player,
a hand of a dealer,
a decision by the player, and
the outcome,
determining at least one criterion for providing a reward to the player;
determining whether the player is qualified to receive a reward based on the at least one criterion and the data;
determining a number of frequent flyer miles based on at least one of:
the data, and
the wager;
awarding the number of frequent flyer miles to the player if the player is qualified to receive a reward; and
displaying the number of frequent flyer miles to the player.

106. A method comprising:
determining if a player busted in at least one play of at least one table game; and
awarding a number of reward points to the player only if the player busted.

107. A method comprising:
determining data associated with at least one play of at least one table game by a player;
determining if the player busted after drawing to a hand having a point total that is not less than a predetermined point total, in which the point total is based on the data; and
awarding a number of reward points to the player if the player busted after drawing to a hand having a point total that is not less than the predetermined point total.

108. A method comprising:
determining data associated with at least one play of at least one table game by a player;
determining if the player busted after drawing to a hand having a point total that is not greater than a predetermined point total, in which the point total is based on the data; and
awarding a number of reward points to the player if the player busted after drawing to a hand having a point total that is not greater than the predetermined point total.

109. A method comprising:
receiving an identifier that identifies a player;
receiving an indication of a wager by the player;
determining an outcome of a play of a table game by the player;
determining whether the outcome is a winning outcome;
determining a number of frequent flyer miles based on the wager; and
awarding the number of frequent flyer miles to the player if the outcome is not a winning outcome.
